(19) United States
(12) Patent Application Publication
(10) Pub. No.: US 2026/0340990 A1
(43) Pub. Date: Oct. 29, 2026

(54) MEDIA PROCESSING SYSTEMS AND METHODS FOR GENERATING USER AND OBJECT PROFILES USING GENERATIVE ARTIFICIAL-INTELLIGENCE MODELS

(71) Applicant: ACCENTURE GLOBAL SOLUTIONS LIMITED, Dublin 4 (IE)

(72) Inventors: Kamal MANNAR, Singapore (SG); Brian Dean Gray, Downers Grove, IL (US); Iair Zonnenschein, Miami, FL (US)

(73) Assignee: ACCENTURE GLOBAL SOLUTIONS LIMITED, Dublin 4 (IE)

(21) Appl. No.: 19/192,944

(22) Filed: Apr. 29, 2025

(51) Int. Cl. G06V 10/764; G06T 7/13; G06T 7/246; G06T 7/50; G06V 10/20; G06V 10/25; G06V 10/40; G06V 10/74; G06V 10/762; G06V 10/82; G06V 20/52; G06V 20/70

(52) U.S. Cl. CPC G06V 10/764; G06T 7/13; G06T 7/246; G06T 7/50; G06V 10/20; G06V 10/25; G06V 10/40; G06V 10/761; G06V 10/762; G06V 10/82; G06V 20/52; G06V 20/70; G06T 2200/24; G06T 2207/20076; G06T 2207/20084; G06T 2207/30241; G06V 2201/08

(57) ABSTRACT

Media processing method, system, and computer-readable storage media for generating user and object profiles are disclosed. Input datasets associated with environment is received from data sources. The input datasets include input media of environment captured from media capturing systems. An object within environment is identified by processing input datasets using vision language model and computer vision model. An event corresponding to object is determined based on object parameters. The event includes action performed by object within environment. A trajectory of object is detected based on event using spatial trajectory model. The input datasets are sampled based on trajectory using sampling parameters. An object profile of object and user profile of user associated with object is generated based on sampled datasets. Recommendations are generated for user based on object profile and user profile using Generative Artificial-Intelligence model. The recommendations are outputted to the user on a user-interface of user device.

### TECHNICAL FIELD

Various examples described herein relate generally to media processing systems and methods for generating user and object profiles using Generative Artificial-Intelligence (Gen-AI) models.

### BACKGROUND

Recent advancements in digital imaging and electronics have yielded a considerable increase in visual systems and their applications in different fields such as object identification and tracking. Object identification and tracking may involve recognizing, categorizing, and tracking objects of interest from captured datasets (e.g., images, videos, and/or the like) of an environment. Objects may include users/customers and physical entities such as objects, customer products, vehicles, equipment, or any other tangible items. Results of the object identification and tracking may be used across a range of tasks supporting context-aware and environment specific processing, personalized offer generations, and/or the like. Personalized offer generations may involve generating personalized offers such as promotions, incentives, and/or recommendations based on a behavior or movement of the identified and tracked objects.

Some object identification systems leverage technologies such as computer vision (CV), sensor integration, Artificial-Intelligence (AI), and Machine Learning (ML) for object identification and tracking. However, with an increase in the number of objects present in the environment and due to complexity of the datasets associated with the environment, these object identification systems may fail to consider real-time context associated with the environment as well as fail to capture immediate and situational factors such as current needs and change in behavior or movement of the objects, physical conditions of the objects, and/or the like. Therefore, the object identification and tracking using these object identification systems may result in inaccurate or irrelevant identification and tracking of the objects in the environment. Inaccurate or irrelevant identification and tracking of the objects may limit scalability, and result in missed opportunities to enhance user/customer experience, which may affect achieving enterprise outcomes.

### SUMMARY

In an aspect, the present disclosure relates to a system including a processor, and a memory coupled to the processor, wherein the memory includes processor-executable instructions, which on execution, cause the processor to receive input datasets associated with an environment from a plurality of data sources, wherein the input datasets include input media of the environment captured from number of media capturing systems, identify at least one object within the environment by processing the received input datasets using a vision language model and a computer vision model, determine at least one event corresponding to the identified at least one object based on a set of object parameters, wherein the at least one event includes at least one action performed by the at least one object within the environment, detect at least one trajectory of the at least one object based on the determined at least one event using a spatial trajectory model, sample the received input datasets based on the detected at least one trajectory using a set of sampling parameters, generate an object profile of the at least one object and a user profile of a user associated with the at least one object based on the sampled datasets, generate a plurality of recommendations for the user based on the generated object profile and the user profile using a Generative Artificial-Intelligence (Gen-AI) model, and output the generated plurality of recommendations for the user on a user interface of a user device.

In another aspect, the present disclosure relates to a method including receiving, by a processor, input datasets associated with an environment from a plurality of data sources, wherein the input datasets include input media of the environment captured from a plurality of media capturing systems, identifying, by the processor, at least one object within the environment by processing the received input datasets using a vision language model and a computer vision model, determining, by the processor, at least one event corresponding to the identified at least one object based on a set of object parameters, wherein the at least one event includes at least one action performed by the at least one object within the environment, detecting, by the processor, at least one trajectory of the at least one object based on the determined at least one event using a spatial trajectory model, sampling, by the processor, the received input datasets based on the detected at least one trajectory using a set of sampling parameters, generating, by the processor, an object profile of the at least one object and a user profile of a user associated with the at least one object based on the sampled datasets, generating, by the processor, a plurality of recommendations for the user based on the generated object profile and the user profile using a Generative Artificial-Intelligence (Gen-AI) model, and outputting, by the processor, the generated plurality of recommendations for the user on a user interface of a user device.

In another aspect, the present disclosure relates to a non-transitory computer readable medium including machine-executable instructions that may be executable by a processor to perform the method as discussed herein.

It is appreciated that method in accordance with the present disclosure can include any combination of the aspects and features described herein. That is, the method in accordance with the present disclosure is not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 illustrates an exemplary system for generating user and object profiles and generating recommendations, in accordance with implementations of the present disclosure.

FIG. 2 illustrates an exemplary detailed architecture of a media processing system depicted in the exemplary system of FIG. 1, in accordance with implementations of the present disclosure.

FIG. 3 is a flow diagram that presents an example computer implemented method for generating user and object profiles using Generative Artificial-Intelligence (Gen-AI) models, in accordance with implementations of the present disclosure.

FIG. 4 is a flow diagram that presents an example computer implemented method for identifying an object within an environment, in accordance with implementations of the present disclosure.

FIGS. 5A and 5B illustrate example scenarios of object identification at a fueling station, in accordance with implementations of the present disclosure.

FIG. 6 is a flow diagram that presents an example computer implemented method for predicting a subsequent state of an object, in accordance with implementations of the present disclosure.

FIG. 7 is a flow diagram that presents an example computer implemented method for estimating distance of an object from an Area of Interest (AOI), in accordance with implementations of the present disclosure.

FIG. 8 is a flow diagram that presents an example computer implemented method for determining an event corresponding to an object, in accordance with implementations of the present disclosure.

FIG. 9 is a flow diagram that presents an example computer implemented method for detecting a trajectory of an object, in accordance with implementations of the present disclosure.

FIG. 10 is a flow diagram that presents an example computer implemented method for sampling input datasets, in accordance with implementations of the present disclosure.

FIG. 11A-11C depict various examples of detection of trajectory states of a vehicle in a gas station environment, in accordance with implementations of the present disclosure.

FIGS. 12A-12C depict exemplary obfuscation detection in input images of a vehicle moving towards a gas pump, in accordance with implementations of the present disclosure.

FIG. 13 is a flow diagram that presents an example computer implemented method for generating an object profile of an object and a user profile of a user associated with the object, in accordance with implementations of the present disclosure.

FIG. 14 is a flow diagram that presents an example computer implemented method for generating recommendations for a user, in accordance with implementations of the present disclosure.

FIG. 15 illustrates an example computer system to implement the media processing system disclosed in the example system of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

Implementations of the present disclosure employ a combination of Generative Artificial-Intelligence (Gen-AI) models (or a combination of agents powered by the Gen-AI models) for performing one or more tasks such as profile generation, recommendation generation, recommendation visualization, and post recommendation analysis.

The profile generation may include generating object profiles of objects and user profiles of users associated with the respective objects. It should be noted that the profile generation may be performed based on an explicit consent from the respective users. The object profiles and the user profiles may be generated by receiving input datasets associated with an environment, identifying and tracking the objects within an environment using Gen-AI models (e.g., computer vision and signal processing models, vision language models (VLMs) and/or the like), determining events corresponding to the identified objects, detecting trajectories of the objects based on the respectively determined events, and sampling the input datasets based on the detected trajectories to generate the user profiles and the object profiles. Sampling of the input datasets across different points of the users/objects may reduce processing load on the Gen-AI models and reduce latency. Therefore, implementations of the present disclosure may enable accurate identification and tracking of the objects/user by integrating real-time data processing, spatial awareness, and the Gen-AI models. Accurate identification and tracking of the objects/user may further result in accurate and efficient generation of the user profiles/object profiles.

The recommendation generation may include determining a behaviour of each of the users from a respective user profile, determining real-time contextual attributes (e.g., current product, promotions by products, competition promotion activities, and other facts impacting the environment such as weather, time of day, and/or the like) of the environment, predicting future user preferences of each of the user by correlating the determined behaviour with the determined real-time contextual attributes of the environment, and predicting the recommendations for each of the users based on the future user preferences. The recommendation visualization may include generating creative contents for the predicted recommendations and generate multiple visualizations to present the created contents. The post recommendation analysis may include monitoring or tracking a change in the behaviour of the user (e.g., a change in purchase patterns, a change in product uptakes, and/or the like) and the monitored or tracked change may be used as feedback for generating the recommendations in future. Therefore, implementations of the present disclosure enable a highly context-aware and personalized user experience, while improving user engagement with enterprises, increasing conversion rates, and fostering user loyalty. It should be noted that the recommendation generation and the post recommendation analysis may be performed based on an explicit consent from the respective users.

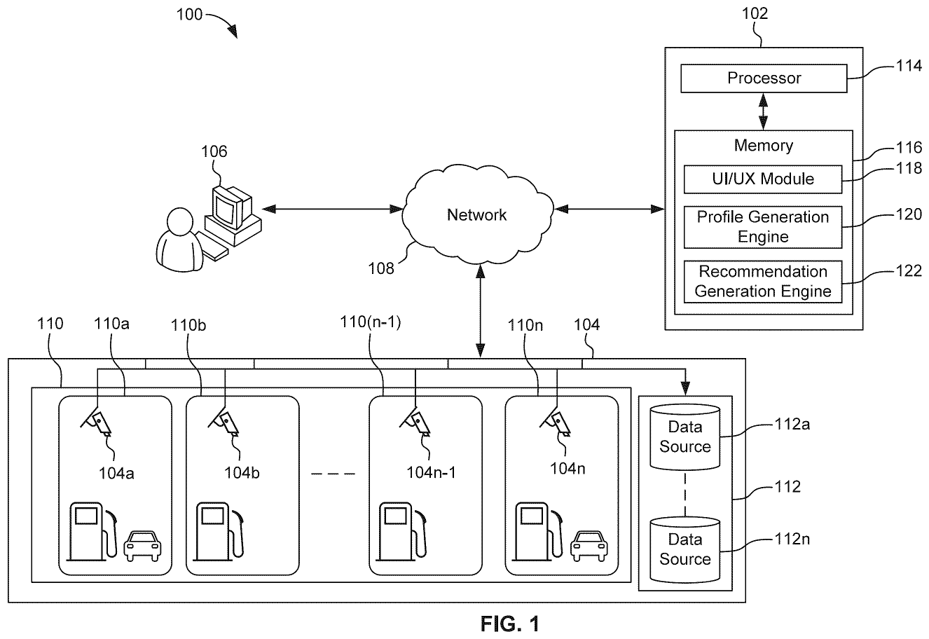

FIG. 1 illustrates an exemplary system 100 used for generating user and object profiles and generating recommendations, in accordance with implementations of the present disclosure. The exemplary system 100, depicted in FIG. 1, includes a media processing system 102, an media capturing systems 104a-104n, and a user device 106. For brevity, only one media processing system, media capturing system, and user device are depicted in FIG. 1. However, in some implementations, the exemplary system 100 may include multiple media processing systems, media capturing systems, and user devices. The media processing system 102 may interact with the media capturing systems 104a-104n and the user device 106 via a network 108. The network 108 may correspond to a communication network. Examples of the network 108 may include, but are not limited to, a Local Area Network (LAN), a Wide Area Network (WAN), the Internet, Wi-Fi, Long Term Evolution (LTE), Worldwide Interoperability for Microwave Access (WiMAX), General Packet Radio Services (GPRS), or a combination thereof. In some examples, the network 108 may be accessed over a wired and/or a wireless communication link.

The media capturing systems 104a-104n may be deployed in multiple areas or regions 110a-110n of an environment 110. The environment 110 may include the multiple areas or regions 110a-110n where users and/or objects operate. Non-limiting examples of the environment 110 may include a warehouse, a manufacturing plant, a hospital, a fueling station (also be referred to as gas station, fuel station, and/or the like), a retail store, a public transportation space, a facility, and/or the like. Examples of the users may include, but are not limited to, customers, clients, patients, buyers, drivers, and/or the like. Examples of the objects may include, but are not limited to, a vehicle, a user, an object, a fuel pump, a fuel dispenser, a point-of-sale system, and/or the like. For simplicity, the media capturing systems 104a-104n associated with the environment 110 like a fueling station is depicted in FIG. 1.

Further, as depicted in FIG. 1, the media capturing systems 104 may capture input datasets from the multiple areas or regions 110a-110n of the environment 110. For example, the exemplary system 100 may include five media capturing systems as 104a-104e for capturing the input datasets from respective regions 110a-110e of the environment 110. Non-limiting examples of the media capturing systems 104a-104n may include a video capturing system, a surveillance system, a multi-camera system, a drone camera, a toll booth camera, and/or the like. The input datasets may include multi-modal datasets. Non-limiting examples of the input datasets may include images, videos, audio, and/or the like. In an example, the input datasets in the form of the images may include images of vehicles, images of fueling stations, images of users (e.g., drivers, customers, staff, and/or the like), images capturing specific actions or events, vehicle movement images, and/or the like. In another example, each of the media capturing systems 104a-104n may capture video snippets for events (e.g., vehicle at pump, customer at aisle, and/or the like) for a pre-defined time period prior to identification of the events (e.g., 30 s before stopping at pump, and 10 s at pump). The media capturing systems 104a-104n may be collectively referred to as an media capturing systems 104.

Further, the media capturing systems 104 may also include data sources 112a-112n. The data sources 112a-112n may be collectively referenced hereinafter as data sources 112 (also be referenced to as databases). Examples of the data sources 112 may include enterprise application, databases, servers, cloud platforms, repositories, Customer Relationship Management (CRM) systems, websites, service history databases, Internet-of-Things (IoT) platforms, customer support platforms, management systems, and/or the like. The input datasets which are captured for the environment 110 using the media capturing systems 104 may be stored in the data sources 112.

Further, the user device 106 may be used by the user to log into and interact with computing platforms being provided by the media processing system 102. A computing platform may execute applications according to implementations of the present disclosure. Examples of the user device 106 may include a server, a notebook, a desktop, a netbook, smartphones, laptops, a tablet, a vehicle dashboard, On-Board Diagnostics (OBD-II) devices, telematics units, Head-Up Displays (HUD), and/or voice-enabled devices. It is contemplated that implementations of the present disclosure may be realized with any appropriate type of user device. Additionally, the user device 106 may include public or non-user-owned interfaces such as digital screens at fuel pumps, kiosks, infotainment systems, or other embedded displays, which may be used to engage with unknown users or transient users. In some examples, the user device 106 may include a web browser application executed thereon, which may be used to display one or more web pages of the computing platform executing applications. In some examples, the user device 106 may display one or more Graphical User Interfaces (GUIs) that enable the user or in some cases unknown users or the transient users to interact with the computing platforms.

By way of an example, the user may use the user device 106 to interact with the media processing system 102. For example, the user may receive recommendations (e.g., personalized offers) from the media processing system 102 via a user interface of the user device 106. The user interface may include a display, a keypad/touchpad, and/or a speaker. For example, the user at a fueling station may use a mobile device to interact with the media processing system 102. Further, the user may receive recommendations on fuel types, discounts, and/or nearby services either through the display on the display of the mobile device or the speaker of the mobile device. Similarly, the user may provide an input via the user interface of the user device 106 to navigate and check for the recommendations related to specific products or items.

In some examples, the media processing system 102 may be implemented as an on-premises system that is operated by an organization or a third-party engaged in cross-platform interactions and data management. In some examples, the media processing system 102 may be implemented as an off-premises system (for example, a cloud or an on-demand system) that may be operated by an organization or a third-party on behalf of the organization. In some examples, the media processing system 102 may be implemented in a cloud environment. For simplicity, the media processing system 102 depicted in FIG. 1 may be a cloud environment that is intended to represent various forms of servers including a web server, an application server, a proxy server, a network server, a server pool, and/or the like. In some examples, the media processing system 102 may include, but are not limited to a server, a back-end system, a desktop, a laptop, a notebook, a tablet, a smartphone, a mobile phone, a vehicle dashboard, an application server, a computing system, and/or the like.

The media processing system 102 includes a processor 114 and a memory 116. In some implementations, the media processing system 102 includes more than one processor. The processor 114 may include, for example, microprocessors, microcomputers, microcontrollers, digital signal processors, central processing units, state machines, logic circuits, and/or any devices that manipulate data or signals based on operational instructions. The memory 116 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM).

The memory 116 may be communicatively coupled to the processor 114. The memory 116 stores a User Interface/User experience (UI/UX) module 118, a profile generation engine 120, and a recommendation generation engine 122. The UI/UX module 118 allows communication of the media processing system 102 with the media capturing systems 104 and the user device 106. For example, the UI/UX module 118 may be used to receive inputs (e.g., the input datasets from the media capturing systems 104 or the data sources 112 of the media capturing systems 104) and transmit outputs (e.g., recommendations on the user interface of the user device 106). The profile generation engine 120, and the recommendation generation engine 122 may be stored as a downloadable library including various instructions. The instructions may be executed by the processor 114 for performing one or more tasks according to the present disclosure.

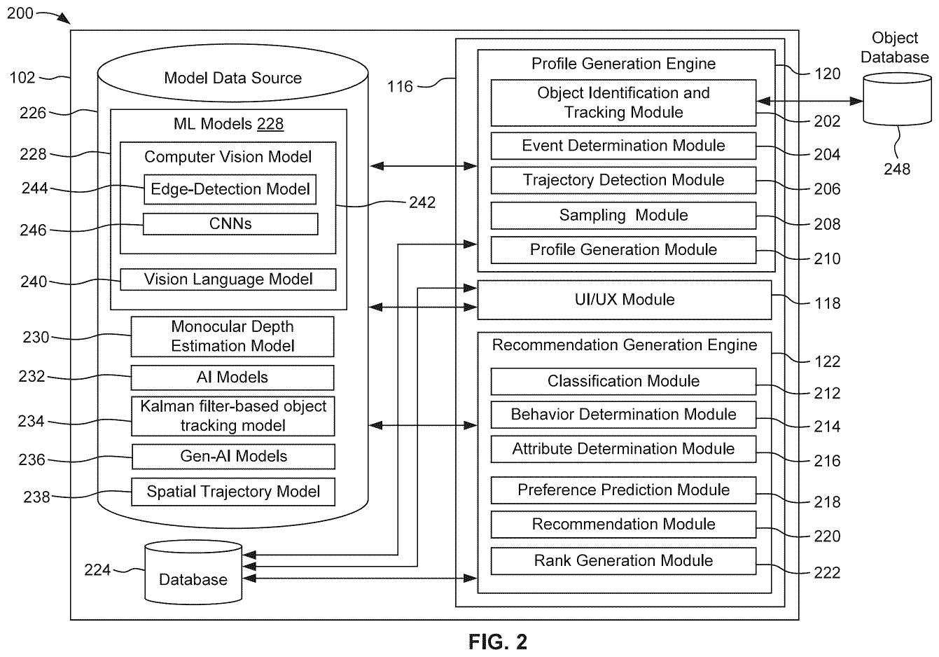

The profile generation engine 120, and the recommendation generation engine 122 may be executed by the processor 114 for generating the user and object profiles, and recommendations to the user, respectively. The generation of the user and object profiles and the recommendations may include various operations such as receiving the input datasets, identifying objects, determining events, detecting trajectories, sampling the input datasets, generating recommendations, outputting recommendations, and/or the like. The operations are further described further in detail in conjunction with FIG. 2 in the present disclosure.

The memory 116 may also store various data (e.g., input datasets, trajectories, sampled input datasets, recommendations, object features, confidence scores of object bounding boxes, textual representations of objects, labels of objects, state transition matrix, vehicle parameters, environmental parameters, states of objects, unique identifiers of objects, object attributes, textual object descriptions, user-related attributes, user descriptions, user preferences, ranks of recommendations, and/or the like, which are described detail in conjunction with later FIGS) that may be captured, processed, and/or required by the media processing system 102.

Various examples of generating the user and object profiles and recommendations for the user are described in conjunction with FIGS. 2-18.

FIG. 2 illustrates an exemplary detailed architecture of the media processing system 102 depicted in the example environment of FIG. 1, in accordance with implementations of the present disclosure. FIG. 2 is explained in conjunction with FIG. 1. As depicted in FIG. 2, the UI/UX module 118, the profile generation engine 120, and the recommendation generation engine 122 of the media processing system 102 may be communicatively coupled to a database 224 for storing various data (e.g., input datasets received from the data sources 112) and/or intermediate results generated by the modules 202-222. The UI/UX module 118, the profile generation engine 120, and the recommendation generation engine 122 may store/extract the various data and/or intermediate results in/from the database 224 as per requirement.

The profile generation engine 120 and the recommendation generation engine 122 may also be communicatively coupled to a model data source 226 (e.g., via the network 108). The model data source 226 may include Machine Learning (ML) models 228, a monocular depth estimation model 230, Artificial-Intelligence (AI) models 232, a Kalman filter-based object tracking model 234, Gen-AI models 236, and a spatial trajectory model 238. Examples of the Gen-AI models 236 may include, but are not limited to, a Generative Pre-trained Transformer (GPT), a Bidirectional Encoder Representations from Transformers (BERT), a Large Language Model (LLM), and/or the like. The profile generation engine 120 and the recommendation generation engine 122 may use the model data source 226 to perform the operations disclosed in detail below.

The UI/UX module 118 may receive the input datasets associated with the environment 110 from the data sources 112 directly or via the database 224. For example, a multi-camera feed from a location (a retail location, a fueling station, and/or the like) may be received. The input datasets may include images, videos, audio, and/or the like of the environment 110 captured from the media capturing systems 104. The input datasets may be provided to the profile generation engine 120.

The profile generation engine 120 may generate a user profile(s) and an object profile(s). The profile generation engine 120 includes an object identification and tracking module 202, an event determination module 204, a trajectory detection module 206, a sampling module 208, and a profile generation module 210.

The object identification and tracking module 202 may identify an object(s) (e.g., a vehicle at pump, a shopper at clothing aisle, and/or the like) within the environment 110 by processing the received input datasets using the ML models 228. The ML models 228 may include a vision language model 240 and a computer vision model 242.

In the present disclosure, identifying the object may include identifying the object within environment 110 and assigning an object label for the object. For identifying the object, the object identification and tracking module 202 may preprocess the received input datasets by performing a noise reduction, a resolution enhancement, and a format normalization on the received input datasets. It may be apparent to a person skilled in art that the noise reduction is performed to remove any random distortions in media (e.g., input media of the environment). The input media may refer to raw data captured from the environment 110 using the media capturing systems 104 (e.g., an image capturing system), which is then processed further for object detection, tracking, event identification, and profile generation. The input media provides visual, audio, spatial, temporal, and/or similar information about objects, people, and activities within the environment (e.g., a gas station or a retail store). Non-limiting examples of the input media include input images, input videos, depth data, thermal images, audio, metadata, image sequences, and/or the like. The resolution enhancement is performed to improve clarity of objects like a blurry street sign in the images. The format normalization may be performed to ensure that input datasets from different cameras, which may vary in resolution or format, is standardized to a consistent form for processing.

After preprocessing the input datasets, the object identification and tracking module 202 may detect boundaries of the object within the environment 110 using an edge-detection model 244 of the computer vision model 242. For example, if the input datasets include an image, the edge-detection model 244 may be used to identify sharp transitions in pixel intensity of the image (e.g., sum, mean, or median intensity of pixels within the image) that define the boundaries of the object. To illustrate, the edge-detection model 244 may be used to compute a gradient of pixels of the image that measures a rate of change of pixel intensity in different directions. The gradient of pixels may be compared with a pre-defined threshold. The gradient of pixels greater than the pre-defined threshold may be considered as edge pixels associated with sharp transitions. The edge pixels may detect the boundaries of the object. The detected boundaries are used to isolate the object from the rest of the scene, allowing the object to be processed separately in subsequent steps. For example, at a fueling station, the boundaries or edges of different objects such as boundaries of fuel pumps, vehicles, person, signage, or surrounding barriers may be detected based identify sharp transitions in pixel intensity of the image captured from a region of the fueling station, creating distinct boundaries that isolate objects. Once the boundaries are detected, the object identification and tracking module 202 may extract object features (high-level features) associated with the object using the Convolutional Neural Networks (CNNs) 246 of the computer vision model 242. In some implementations, the CNNs may correspond to an EfficientDet model, and is a fine-tuned model based on an application. The object features may include a shape, a color, and/or a texture of the object. The EfficientDet model may balance accuracy in object identification and efficiency in computational resource usage, enabling real-time processing in environments with high throughput requirements, such as fueling stations or retail stores. By way of an example, the object features for the fuel pump at the fueling station, may include a square shape, a blue color, and a mantellic texture of the fuel pump, while other objects at the fueling station may have different object features (e.g., texture, color, shape, and/or the like). By way of another example, for a retail store, the object features may include a rectangular shape and a white label of a shelf. The object features are used to categorize, track, and associate the object across multiple frames in real-time, enabling efficient monitoring of customer and vehicle behavior at key locations like fuel pumps or store aisles.

Upon extracting the object features, the object identification and tracking module 202 may generate object bounding boxes with confidence scores based on the extracted object features, which indicate a probability that the object is correctly identified within the bounding boxes. The bounding boxes have x and y coordinates which may be further used for tracking purpose. Each object bounding box is assigned a confidence score, which represents certainty in identifying the object within the object bounding box. For example, a fuel pump may have an object bounding box with a confidence score of 0.92, indicating a high likelihood that the object is correctly identified as a fuel pump. Other objects, such as a nearby sign with similar features, may have a lower confidence score of 0.75 or less. Additionally, or alternatively, the object identification and tracking module 202 may generate visual embeddings. The visual embeddings are numerical vectors in a high-dimensional space that encodes essential visual information about the object. For example, the visual embeddings generated for an image of the fuel pump may capture the object features like shape, color, texture, and appearance in relation to other similar objects like fuel tanks or gas stations.

Based on the visual embeddings and the generated object bounding boxes, the object identification and tracking module 202 may generate textual representations/textual descriptions (e.g., a fuel pump, a display case, or a shelf), for each of the object using the vision language model 240. Further, the object identification and tracking module 202 may compare the textual representations with a predefined object database 248. After comparison, the object identification and tracking module 202 may assign an object label to the object based on a semantic similarity between the generated textual representations and the predefined object database 248. With respect to the example of the environment as the fueling station, the predefined object database 248 may include predefined labels and textual representations/descriptions of various fueling station equipment. For example, a textual representation/description generated by the object identification and tracking module 202 of the fuel pump is “red fuel pump with a metallic nozzle”. In such a case the textual representation/description “red fuel pump with a metallic nozzle” may be compared/matched with entries in the predefined object database 248 and accordingly assign the object label. In an example, the object label may be assigned based on the highest semantic similarity between the generated textual representation/description and the matched entry in the predefined object database 248. If the textual representation/description closely matches the entry for “fuel pump”, the object may be labeled accordingly.

Once the object label is assigned for the object, the object identification and tracking module 202 may estimate a distance of the object from an area of interest, determine a set of object parameters, predict subsequent state of the object, and assign a unique Identifier (ID) for the object, for tracking the object within the environment 110.

For estimating the distance of the object, the object identification and tracking module 202 may convert position coordinates of the identified object (e.g., image coordinates) into real-world position coordinates using an estimated homograph matrix. The homograph matrix estimation begins with, for example, a ground measurement of four physically identifiable landmark points within each of the input datasets, such as corners of a parking space at a fuel pump. The real-world position coordinates of the four points may be measured precisely, denoted as [X₁, Y₁], [X₂, Y₂], [X₃, Y₃], [X₄, Y₄], while the corresponding position coordinates are represented as [x₁, y₁], [x₂, y₂], [x₃, y₃], [x₄, y₄]. To estimate the homographic matrix, a Random Sample Consensus (RANSAC) based method may be employed. The RANSAC based method iteratively selects random subsets of coordinate pairs (e.g., including the real-world position coordinates and the image coordinates) to estimate the homographic matrix, correcting for errors by discarding outliers and refining the homograph matrix estimation. The homograph matrix may be applied on the image coordinates of the object. For example, for vehicle centre image coordinates [xᵥₑₕ, yᵥₑₕ], the homograph matrix may be applied to generate the real-world coordinates [Xᵥₑₕ, Yᵥₑₕ]. Similarly, for a gas pump centre image coordinate [yₚᵤₘₚ, yₚᵤₘₚ], the real-world coordinates [Xₚᵤₘₚ, Yₚᵤₘₚ] may be generated.

For example, when a vehicle enters a fueling station, the object identification and tracking module 202 may identify the vehicle from the received input dataset that include an image of the vehicle. A position of the vehicle may be represented in the image of the vehicle using image coordinates or position coordinates of the vehicle, such as (450, 300), where 450 is horizontal (x) position, and 300 is the vertical (y) position in the image. The image coordinates or position coordinates of the vehicle may include skewed and Two-Dimensional (2D) image coordinates.

However, the image coordinates or the position coordinates of the vehicle are based on a perspective of the media capturing systems 104 and may represent position of the vehicle within the image frame rather than an actual location of the vehicle in the real world. Therefore, the image coordinates or position coordinates of the vehicle are converted into the real-world position coordinates. To convert the image coordinates or position coordinates of the vehicle into real-world position coordinates (e.g., meters from an entrance or a pump), the estimated homograph matrix may be used. The estimated homograph matrix mathematically transforms the image coordinates or position coordinates of the vehicle into the real-world position coordinates (e.g., including accurate 2D real-world positions) by accounting for camera angle, lens distortion, and perspective differences. Therefore, using the homograph matrix, distorted positions of the object and projects coordinates of the object may be corrected onto a flat plane for accurate tracking. After applying the estimated homograph matrix, the converted real-world position coordinates may be 5.2 meters, 3.8 meters, which are different from the image coordinates or position coordinates of the vehicle (450, 300). After applying the estimated homograph matrix, the position of the vehicle may be accurately mapped to fueling station layout, showing that the vehicle is 5.2 meters from the entrance and 3.8 meters from the pump.

Upon converting the position coordinates of the object into the real-world position coordinates, the object identification and tracking module 202 may generate depth data of the input datasets using the monocular depth estimation model 230. For example, the object identification and tracking module 202 may use the monocular depth estimation model 230 to analyze the input datasets to estimate how far the object is from the media capturing device, based on visual cues like size, shading, and perspective.

Once the depth data is generated, the object identification and tracking module 202 may determine an area of interest (AOI) (e.g., an area around a fueling pump where the vehicle is expected to stop for refueling.) within the input datasets based on the generated depth data and the real-world position coordinates of the object. For example, the AOI may be a fuel pump, a shopping aisle, a checkout counter, an operating table, a sterile storage area, and/or the like. The AOI may be determined for each of the object. The AOI in the input dataset may correspond to frames of interest. Further, the object identification and tracking module 202 may estimate the distance (e.g., Euclidean distance) of the object from the determined AOI.

In some implementations, the object identification and tracking module 202 may perform outlier removal based on the estimated position using the Kalman filter-based object tracking model 234 and actual position of the object. The outlier removal involves removing the object/object features detected from the CNNs 246 and locations of the object that are not accurate. If a Hungarian method does not associate the object detected by CNNs 246 with existing objects, and a new object is only present for a defined number of frames (e.g., 5 frames), then the object detections may be discarded as outliers. If the detected object lasts for more than the defined number of frames, a new unique identifier may be generated for the object. The outlier removal uses the state vector, which includes the position and the velocity of the object, to ensure that only reliable detections are maintained.

The object identification and tracking module 202 may estimate the set of object parameters (e.g., position, and velocity) associated with the object by processing the real-world position coordinates using a Kalman filter-based object tracking model 234. The Kalman filter-based object tracking model 234 may estimate the set of object parameters more precisely by refining position and velocity estimates of the object over time. The Kalman filter-based object tracking model 234 corrects for noise or inaccuracies in the input datasets (e.g., multimedia data) captured using the media capturing systems 104, or in the object identification.

In some implementations, the object identification and tracking module 202 may compute a state vector of the object based on the set of object parameters (e.g., vehicle parameters, customer related parameters, and/or the like). The set of object parameters include a position value and a velocity value of the object. For example, the state vector may be represented as [x, y, vₓ, v_{y}], where [x, y] represents a position of the object in Two-Dimensional (2D) space and [vₓ,v_{y}] represents velocity components in x and y directions. The velocity coordinates represent how fast and in which direction the object is moving. The state vector encapsulates a current location and movement dynamics of the object, providing foundational data needed for future predictions. Based on the state vector, the object identification and tracking module 202 may generate a state transition matrix using one of the AI models 232. The state transition matrix defines how position and velocity of the object are expected to evolve over time. Further, based on the state transition matrix, the object identification and tracking module 202 may predict a subsequent state (e.g., a subsequent behavior) of the object.

The object detection and tracking module 202 may assign the unique ID for the object using one of the AI models 232. The unique identifier remains consistent for the object across temporal instances, that is, even if the object moves across different frames, the same unique ID is retained. For example, if the object returns to the environment 110 after varying intervals of time (e.g., an hour, a day, a week, a month, and/or the like), the unique ID remains unchanged. The same unique ID allows the object to be tracked over time, ensuring that an associated object profile, including previously collected information (e.g., historical information), remains persistent. When the object returns to the environment 110, whether for subsequent interactions or repeated appearances, the object detection and tracking module 202 updates the existing object profile with any new information gathered. Therefore, an iterative process of dynamically refining historical information enables the media processing system 102 to perform accurate and contextually relevant recommendations, evolving from an initially unknown object to a semi-known object based on accumulated data.

The object label assigned for the object, the estimated distance of the object from the AOI, the set of object parameters, the predicted subsequent state of the object, and the unique identifier of the object may be provided to the event determination module 204 and/or stored in the database 224.

The event determination module 204 may determine an event corresponding to the identified object based on the set of object parameters. The event may include an action performed by the object within the environment 110. For example, in retail, the event for the identified object may be actions including, but not limited to, a product being purchased, restocked, returned, or moved within a store, a customer moving towards specific sections, making purchase, customer entering/exiting/stopping the store, a shopper at clothing aisle, and/or the like. Similarly, at a fueling station, events for the identified object may be fuel dispensing, payment processing, a vehicle at pump, fuel pump activation/deactivation, a vehicle entering/exiting/stopping at the station, and/or the like.

For determining the event, the event determination module 204 may determine environmental parameters of the environment 110 based on sensor data and the input datasets captured from the media capturing systems 104. The environmental parameters may influence behavior of the object. The environmental parameters may include, but are not limited to, a time of a day, weather conditions (e.g., clear skies, rain, fog, and/or the like), and a congestion level (e.g., traffic density or road occupancy, queue lengths, space utilization, and or the like). The environmental parameters provide essential context for interpreting behavior of the object, as external conditions may significantly influence movement patterns of the object. By way of an example, wet or icy road conditions may affect a braking distance or turning behavior of a vehicle, while high traffic congestion may cause vehicles to slow down or stop frequently. By way of another example, loud background music in the retail store may cause customers to feel rushed or stressed, leading the customers to make quicker purchase decisions, while a crowded checkout area may cause the customers to hesitate, abandon carts, and/or change purchasing behavior of the customers due to long wait times.

Further, the event determination module 204 may determine a movement of the object based on the set of object parameters, and the environmental parameters. The movement may correspond to specific behaviors, such as accelerating, braking, turning, maintaining a steady speed, picking up items, changing aisles, and/or moving towards specific area. Further, the event determination module 204 may compare the determined movement of the object with historical object behaviors in similar environmental conditions associated with the similar environmental parameters. The historical object behaviors may indicate previous movements or operations of the objects. By analyzing historical behaviors of similar objects in the similar environmental conditions (e.g., previous vehicles under similar weather and traffic conditions), the event determination module 204 checks if a current behavior of the object aligns with expected standards. The comparison provides a context-driven analysis of whether movement of the object is standard (normal) or unusual, which is essential for detecting events.

Based on results of the comparison, the event determination module 204 may validate the determined movement of the object using one of the Gen-AI models 236 based on results of comparison. The one of the Gen-AI models 236 may be used to synthesize the historical behavior comparison with real-time data to confirm if the movement of the object is accurate. For example, if the event determination module 204 detects a sudden deceleration in a vehicle's velocity in an unexpected location (e.g., a highway with no obstacles), the one of the Gen-AI models 236 may be used to identify if the sudden deceleration corresponds to a collision or a traffic stop. The one of the Gen-AI models 236 may be used to generate predictions based on learned patterns of object behaviors, considering various factors, such as external factors, environment conditions, and typical movement patterns of objects. If the determined movement of the object is the expected standard (e.g., during the similar environment), the event determination module 204 may identify a successful validation of the determined movement of the object. If the determined movement of the object is not the expected standard or unusual, the event determination module 204 may identify an unsuccessful validation of the determined movement of the object.

Upon the successful validation, the event determination module 204 may determine the event corresponding to the identified object. The event may be a simple action (e.g., a vehicle turning left) to more complex events such as accidents, unexpected stops, or detours. When the validation is the unsuccessful validation, the movement may be determined iteratively until the validation is successful. The determined event may be provided to the trajectory detection module 206 and/or stored in the database 224.

The trajectory detection module 206 may detect a trajectory of the object based on the determined event using a spatial trajectory model 238. To detect the trajectory, the trajectory detection module 206 may obtain the unique identifier of the object (generated by the object identification and tracking module 202) and determine an object location information associated with the object using the spatial trajectory model 238. The object location information may be determined by processing the predicted subsequent state, and a change in the distance of the object using the spatial trajectory model 238. The unique identifier is used for distinguishing the object from other objects in the environment, and the object location information provides context for movement of the object within the environment 110. Further, the trajectory detection module 206 may identify a change in the movement of the object within the environment 110 based on the determined unique identifier, and the object location information. The trajectory detection module 206 may further determine a behavior of the object corresponding to the determined event based on the identified change.

For example, when the vehicle “A” approaches a gas station, the trajectory detection module 206, using the unique identifier and vehicle location information (i.e., the object location information), may continuously monitor changes in movement of the vehicle “A”. The trajectory detection module 206 may identify a decrease in speed as the vehicle “A” slows from 60 mph to 30 mph, indicating that the vehicle “A” is preparing to stop or turn into the gas station. Additionally, the trajectory detection module 206 may also track the change in movement when the vehicle “A” turns off a main road or changes lanes towards exist of the gas station. The trajectory detection module 206 may also identify a complete stop when the vehicle “A” halts at entrance of the gas station. Variations in speed, direction, and path are analyzed in real-time, allowing the trajectory detection module 206 to accurately determine a behavior of the vehicle “A” as the vehicle “A” approaches and enters the gas station.

Along with the determination of the behavior of the object, the trajectory detection module 206 may classify the event and the object into object state categories based on the determined behavior of the object. The object state categories provide a contextual status of the object, and it may vary based on the environment 110. Further, the trajectory detection module 206 may determine a trajectory path followed by the object based on the classification. Based on a sequence of the determined object state categories, the trajectory path may be determined.

For example, for the fueling station, the object state categories may include, but are not limited to, driving near gas station, driving towards gas pump, stopped at gas pump, ready to start fueling, completing fueling and departing and/or the like. In such a case, the trajectory path may be a sequence of movements from the entrance of the station, navigating through lanes, positioning correctly at the gas pump, and then leaving after refueling. Similarly, for the retail store, the object state categories may be entering store, browsing specific product aisles, picking up items, approaching checkout counter, and/or completing a purchase. In such as case, the trajectory path may be from moving from entrance to an electronics section, and then to checkout.

Once the trajectory path is determined, the trajectory detection module 206 may validate the determined trajectory path followed by the object using one of the Gen-AI models 236. The one of the Gen-AI models 236 may correspond to a multimodal LLM. As will be appreciated to a person skilled in the art that the multimodal LLM processes and generates responses based on multiple modalities or types of input data, such as text, images, audio, and even video. Further, the validation may be a successful validation or an unsuccessful validation. In some implementations, based on the comparison, a similarity between the trajectory path and predictions of the trajectory path may be determined. If the similarity is within a predefined threshold range, the validation may be considered as the successful validation. Otherwise, when the similarity is out of the predefined threshold range, the validation may be considered as the unsuccessful validation. The trajectory detection module 206 may detect the trajectory of the object based on results of validation. For example, if the validation is the unsuccessful validation, the trajectory path may be regenerated until the validation is the successful validation. On the other hand, if the validation is the successful validation, the trajectory path may be considered as the trajectory for analysis. The determined trajectory may be provided to the sampling module 208 and/or stored in the database 224.

The sampling module 208 may sample the received input datasets based on the detected trajectory using a set of sampling parameters. The set of sampling parameters may include, but are not limited to, sampling rates, confidence threshold value, probability of trajectory state transition, a time window for transition, and/or the like.

For sampling, the sampling module 208 may detect a trajectory state of the object based on the detected trajectory path using the spatial trajectory model 238. The trajectory state provides movement dynamics of the object. Examples of the trajectory state may include, but are not limited to, movement to gas station, transition to gas pump, stationary at gas pump, movement towards a store entrance, browsing products, interacting with display, exiting store, and/or the like.

In some implementations, the sampling module 208 may automatically derive the trajectory state of the object by leveraging the set of object parameters (e.g., velocity) and changes along with the position/distance of the object relative to the AOI (e.g., a fuel pump). The sampling module 208 may employ a Hidden Markov Model (HMM) with defined latent states and data observed from spatial or geometric calculations for deriving the trajectory state of the object. In some examples, the latent states may include driving into a gas station, driving on a road nearby, waiting for a gas pump, driving and stopping at a gas pump, fueling or stationary at a pump, driving out of a gas station The data observed from the spatial or geometric calculations may include probability of being in a current state (e.g., driving into a gas station) and a probability of transitioning to a new state (e.g., driving and stopping at a gas pump).

While implementations of the present disclosure are further described by considering the environment 110 like the fueling station and the input datasets including images of the environment 110, it is contemplated that implementations of the present disclosure may be realized by considering other environments and the input datasets of different formats. Considering the environment 110 like the fueling station, trajectory states of the object like vehicle may represent different stages of vehicle movement and interaction with a gas station, such as: driving near gas station, driving towards gas pump, stopped at gas pump, and/or ready to start fueling. The trajectory states may be used further to sample input images of the vehicle based on a trajectory of the input images to optimize number of images that are integrated for inferencing the vison language model while ensuring that the input images that are collected have the optimized chance of having full details of the vehicle (e.g., a license plate, a vehicle profile, a close-up view of vehicle, and/or the like) to create a vehicle profile for offer match.

The sampling module 208 may train the HMM and use the trained HMM for detecting the trajectory state of the vehicle. The HMM may include parameters such as transition matrix “A”, emission matrix “B”, and an initial state probability vector “T”. Initially, the parameters may be learned from historical vehicle trajectory data. The historical vehicle trajectory data may refer to trajectory data related to vehicles that have been tracked over time. For example, “n” number of vehicles tracked across different times of a day and days of a week to capture variations in driving behaviour (peak vs. off-peak).

For training of the HMM, the sampling module 208 may define hidden trajectory states such as:
S1: Driving Near Fueling Station
S2: Driving Towards Fuel Pump
S3: Stopped at Fuel Pump
S4: Ready to Start Fueling

The hidden trajectory states are interconnected through a probability of trajectory state transition of the vehicle from the current trajectory state to the subsequent trajectory state, which quantify the likelihood of the vehicle transitioning from one state to another, which may be represented using the transition matrix “A”. The transition matrix “A” is a square matrix where each entry A[i, j]=P(S_j|S_i) represents the probability of trajectory state transition from state S_i to S_j. The transition matrix “A” is given as:

$$A = [ \begin{matrix}P ( S 1 \vert S 1 ) & P ( S 2 \vert S 1 ) & 0 & 0 \\ P ( S 1 \vert S 2 ) & P ( S 2 \vert S 2 ) & P ( S 3 \vert S 2 ) & 0 \\ 0 & P ( S 2 \vert S 3 ) & P ( S 3 \vert S 3 ) & P ( S 4 \vert S 3 ) \\ 0 & 0 & P ( S 3 \vert S 4 ) & P ( S 4 \vert S 4 )\end{matrix} ]$$

In the transition matrix, diagonal elements represent probability of staying in the same state (e.g., P(S1|S1)), the off-diagonal elements represent probability of moving to another state (e.g., P(S2|S1)), and zeros represent impossible transitions (e.g., direct jump from S1 to S4).

The sampling module 208 may determine emission probabilities using a Gaussian mixture model. The emission probabilities provide the likelihood of observing a particular feature vector (e.g., speed) given a hidden trajectory state of the vehicle. The emission probabilities may be represented as:

$$B = P ( Ot \vert S i ) = {\sum }_{k = 1}^{K} {w}_{ik} \cdot N ( {O}_{t} \vert {μ}_{k , \sum k} )$$

where,
N(O_t|μ_{ik}, Σ_{ik}) is Gaussian distribution with uₖ mean and Σₖ covariance of k^{th} Gaussian component,
wiₖ is mixture weight for the k^{th} Gaussian component in state i,
K is number of Gaussian components in a mixture model,
O_t is observation at time t (e.g., speed, location, and/or the like), and
S_i is the current trajectory state (e.g., “stopped at fuel pump”).

The sampling module 208 may define the initial state probability vector as:

π=[P(S₁),P(S₂),P(S₃),P(S₄)]

wherein: P(Sᵢ) represents the probability of the vehicle starting in trajectory state Sᵢ, for i∈{1, 2, 3, 4}. The sum of all initial trajectory state probabilities equals 1, i.e., P(S₁)+P(S₂)+P(S₃)+P (S₄)=1.

The sampling module 208 may utilize a labeled sequence of vehicle trajectory data as training data for training of the HMM based on the transition matrix, the determined emission probabilities and the initial state probability vector. The training data may include both observed features (e.g., speed, acceleration, and/or the like) of the vehicle and corresponding trajectory states (e.g., driving near gas station, stopped at gas pump, and/or the like) of the vehicle. For example, the training data includes data from ‘n’ number of vehicles, with labeled time sequences that capture diverse customer journey scenarios. The scenarios may include vehicles that are at the fueling station but do not stop at the fuel pump, vehicles queuing for a fuel pump but leaving the queue without fueling, and vehicles stopping at the fuel pump but not initiating fueling. To enhance robustness of the HMM, the sampling module 208 may use synthetic data along with the training data for training of the HMM. The synthetic data may also be generated to simulate various customer journey behaviors, derived from patterns observed in the real-world data. Further, the sampling module may initialize the determined emission probabilities “B” are initialized using parameters drawn from a Gaussian distribution to effectively model the likelihood of the training data based on each trajectory state. Thereafter, the sampling module 208 may iteratively optimize the parameters of the HMM using an Expectation-Maximization (EM) method. The EM method includes Expectation (E) step and Maximization (M) step. The E step estimates the probabilities for the hidden trajectory states based on the current parameters of the HMM. The M step updates the parameters of the HMM to maximize the likelihood of the training data. The EM method fine-tunes the parameters of the HMM based on real-world vehicle data. The iterative process continues until convergence, ensuring the parameters of the HMM are accurately represent the training data.

During an inference phase, the sampling module 208 may provide an input to the HMM. The input may include time-sequenced observations derived from input datasets (e.g., a video) processing, aggregated over a pre-defined time window (e.g., 5 sec.) as well as the following attributes:

Speed of the vehicle (sₜ): Measured in meters per second (m/s) and obtained through analysis of motion of the vehicle across consecutive image frames of the input datasets.
Coordinates (xₜ, yₜ): Position of the vehicle represented in a 2D spatial coordinate system.
Distance from the gas pump (dₜ): The Euclidean distance calculated between the current position of the vehicle and a nearest fuel pump.
Acceleration (aₜ): Determined from a rate of change in speed over time, indicating whether the vehicle is accelerating or decelerating.
Angle of approach (θₜ): An angle formed between a movement vector of the vehicle and a directional vector pointing towards the gas pump, indicating the approach trajectory of the vehicle.

In an example, the time sequenced observations may be represented as:

O={(sₜ,xₜ,yₜ,aₜ,θₜ)}

where t=1 to T, and “t” is the number of time steps.

Upon receiving the input, the HMM may employ a Viterbi method to identify the most probable sequence of the trajectory states based on the input. The Viterbi method operates in three stages including initialization, recursion, and termination. During the initialization, the initial probabilities of being in each trajectory state may be computed at first time step, incorporating initial state probabilities and the emission probabilities of a first observation, defined as:

δ₁(i)=π_{i.}Bᵢ(O₁)

The recursion may then iteratively update the probabilities for subsequent time steps, considering the transition probabilities between the trajectory states and the likelihood of current observations. The recursion may also calculate the probability of being in a given state at time “t” by maximizing product of the previous state's probability, the transition probability, and the current observation's emission probability, which is computed as:

δₜ(j)=maxᵢ[δₜ₋₁(i)·Aᵢⱼ]·Bⱼ(Oₜ)

The termination of the Viterbi method may identify the highest probability path across all possible ending trajectory states. The highest probability path may be traced to obtain an optimal trajectory state sequence. Further, backtracking may be performed through the computed trajectory paths to determine the optimal sequence of the trajectory states. The optimal sequence represents the most probable trajectory of the vehicle based on the observed data and the learned parameters.

Once the trajectory state of the vehicle is detected, the sampling module 208 may then compute a confidence threshold value (e.g., 95%, 90%, 80%, and/or the like) for the detected trajectory state based on the determined set of object parameters (determined by the object identification and tracking module 202). The confidence threshold value indicates a likelihood of a relevant state change. For example, for the environment 110 like the fueling station, a 95% confidence threshold value may be computed when the vehicle slows down to align with a fuel pump and a 90% confidence threshold value may be computed when the vehicle remains stationary, indicating that a driver of the vehicle is preparing to fuel. Using the computed confidence threshold value, the sampling module 208 may determine a probability of trajectory state transition from a current trajectory state to the subsequent trajectory state. For example, the probability of trajectory state transition may be 85% chances that the vehicle may start fueling based on the confidence threshold value, and/or driver's actions like opening a fuel door.

Once the probability is determined, the sampling module 208 may further determine a time window (e.g., 1 s, 2 s, 3 s, . . . , ns, and/or the like) corresponding to the probability of trajectory state transition of the object based on the determined probability. For example, a five second window may be determined for moving from a transition state to a stationary state.

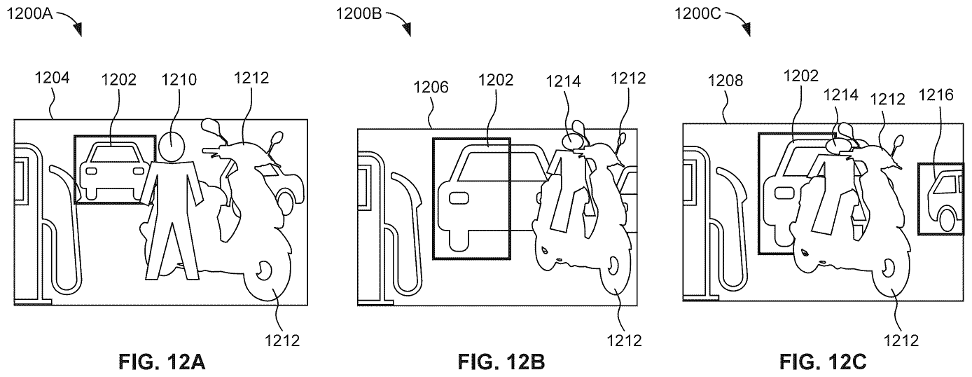

Further, the sampling module 208 may detect a presence of an obfuscation within the received input datasets using the vision language model 240 of the ML models 228. The presence of the obfuscation may indicate presence of other objects or other users blocking the object in the input datasets received for the respective environment 110. For example, consider that a driver of a “vehicle A” is preparing to fuel at a “fuel pump A” and a fuel pump operator and a vehicle B starts moving towards the “fuel pump A”. In such a scenario, presence of the fuel pump operator and the vehicle B may be considered as the presence of the obfuscation. In some examples, the obfuscation may be detected as low obfuscation, a medium obfuscation, a high obfuscation, and/or the like, which are described along with examples in FIGS. 12A-12C.

Upon detecting the presence of the obfuscation, the sampling module 208 may further filter datasets including the presence of the obfuscation (e.g., 1%, 5%, 10%, 12%, 15%, . . . , and/or the like) from the received input datasets. If an input dataset including a view captured form the media capturing systems 104 is partially blocked by another object (e.g., a vehicle, person, and/or the like), the obfuscation may be detected in image frames of the input images, and affected frames are filtered out. The sampling module 208 may determine an appropriate subset of the received input datasets (e.g., a front view of vehicle, a side view of vehicle, a visible license plate, and/or the like) based on the filtered datasets and an associated probability using one of the Gen-AI models 236. The appropriate subset includes image frames of the object selected based on the determined set of object parameters and the trajectory state transition.

The sampling module 208 may further sample the determined appropriate subset of the received input datasets based on a sampling rate, the determined probability, and the determined time window. The sampling rate includes a frame rate, an object occlusion status, and confidence threshold value. In some implementations, the sampling module 208 may dynamically adjust the sampling rate based on one of a velocity of the object, and the object from the AOI. For example, when the vehicle approaches the fueling pump at high speed, the sampling module 208 increases the sampling rate to capture detailed images for accurate trajectory analysis. Conversely, when the vehicle is stationary or moving slowly, the sampling rate is reduced to optimize resource usage. Further, the sampling module 208 may fine-tune the Gen-AI models 236 based on the dynamically adjusted sampling rate. The fine-tuning involves updating model parameters to improve performance in real-time, ensuring that the media processing system 102 maintains high accuracy in detecting trajectory states, object behavior, and potential state transitions while minimizing data redundancy and processing overhead. The sampled datasets may be provided to the profile generation module 210.

The profile generation module 210 may generate the object profile of the object and the user profile of the user associated with the object based on the sampled datasets. While generating the profiles, the profile generation module 210 may determine object attributes corresponding to the object by analyzing the sampled datasets. The object attributes include one of a make and a model of the object (e.g., ABC), a physical condition of the object (e.g., scratched bumper, tinted windows, and/or the like), a vehicle type, a license plate (e.g., XYZ-1234), requirement of vehicle wash, a recommended fuel type, customizations (e.g., a roof rack, a hitch, fog lights, and/or the like), and/or the like. The profile generation module 210 may generate a textual object description of the object by applying the determined object attributes to the vision language model 240. For example, the textual description may be “A red ABC with tinted windows and a scratched bumper, license plate ABC-1234”. In some implementations, the profile generation module 210 enhances the object profile of the object and the user profile of the user by incorporating real-time sensory data in addition to historical behavioral patterns. To illustrate, rather than replacing a previous object profile (e.g., product purchase frequency, visit patterns, and/or the like)/user profile, the profile generation module 210 augments the previous object profile/user profile with contextual, real-time state or condition of the object (e.g., current vehicle cleanliness, visible damage, modifications, and/or the like), thereby enabling more precise and situationally aware personalization for known users. The integration of historical and real-time data facilitates dynamic profile enrichment that supports more accurate targeting and recommendation strategies.

Additionally, the profile generation module 210 may detect user-related attributes corresponding to the user from the sampled datasets. The user-related attributes include a number of occupants visible around the object, browsing behavior, a user behavior, a user purchase history, a user lifestyle history, a user visit frequency, and/or the like. The user-related attributes may be detected and used only upon receiving an explicit consent received from the user. Further, the profile generation module 210 may generate a prompt for the detected user-related attributes corresponding to the user. For example, if the vehicle arrives with persons of different age groups, and the driver frequently buys snacks and coffee, the prompt may be “Suggest family-friendly snacks and a coffee discount to the driver of ABC”.

The profile generation module 210 may correlate the detected user-related attributes with contextual attributes using one of the Gen-AI models 236 in response to the generated prompt. The contextual attributes include a time of day and weather conditions, and historical transaction data of similar users. The profile generation module 210 may generate a user description for the user as a response based on the correlation. For example, the user description may be “a driver with another person, frequently purchasing coffee and snacks during morning hours, likely to respond to family-oriented promotions on cold, rainy days”. The profile generation module 210 may generate the object profile of the object and the user profile of the user based on the generated user description and the textual object description. The object profile and the user profile may be provided to the recommendation generation engine 122 and/or may be stored in the database 224.

The recommendation generation engine 122 may be employed for generating recommendations. The recommendation generation engine 122 may generate the recommendations for the user based on the generated object profile and the user profile using one of the Gen-AI models 236. The recommendations may include a range of attractive bundles to enhance user convenience and satisfaction. For example, the recommendations may include a car care pack for maintaining vehicle performance, a car wash combo for a spotless and refreshed look, an energy boost deal to keep drivers alert with premium snacks and beverages, snack attack bundle offers which is a perfect mix of treats for road trips, a winter warm-up that provides hot drinks and cozy essentials, a night-time fuel deal, and/or the like. The recommendation generation engine 122 may include a classification module 212, a behavior determination module 214, an attribute determination module 216, a preference prediction module 218, a recommendation module 220, and a rank generation module 222.

The classification module 212 may classify the object and the user into behavioral clusters based on the generated textual object description and the user description. The behavioral clusters represent groups of users and objects that exhibit similar behaviors, preferences, and contextual interactions. For example, a user driving a red ABC vehicle with another person who frequently purchases coffee and snacks in the morning may be classified into a cluster representing “family-oriented morning commuters”. Following the classification, the behavior determination module 214 may determine a behavior of the user based on the classified behavioral cluster and a similar user behavior prestored in the database 224. The behavior determination module 214 may compare the users' current actions with historical behavior data of similar users stored in the database 224 to identify patterns and predict future behaviors. For example, if users in a same behavioral cluster often respond positively to coffee promotions on cold mornings, the behavior determination module 214 infers that a current user may exhibit similar behavior.

Further, the attribute determination module 216 may determine real-time contextual attributes (e.g., weather conditions, time of day, location, event-driven factors, and/or the like) of the environment 110. The contextual attributes tailor recommendations to immediate environmental conditions.

For example, on a rainy morning, the recommendation generation engine 122 may recognize that users in a behavioral cluster prefer hot beverages and warm snacks and accordingly provide recommendations (e.g., discounts on hot beverages) to the users in the behavioral cluster. To provide the recommendations, the attribute determination module 216 may apply a clustering methods, such as K-means or Density-Based Spatial Clustering of Applications with Noise (DBSCAN), to group users based on past interactions, preferences, responses to environmental factors, previous responses to the recommendations, purchase patterns at a store, profiles of objects associated with the users, and/or the like. Such grouping of the users may aid in identifying a change in a behavior of each of the users in a same group and adapting the recommendations to any user in the group based on real-time input datasets captured for the respective group of users. The attribute determination module 216 may refine groups of users using machine learning (ML) models and capture changing patterns of the users in real-time. Upon grouping the users, the preference prediction module 218 may predict future user preferences of the user by correlating the determined behavior with the determined real-time contextual attributes, which anticipate what the user is likely to want next. For the prediction, a time-series forecasting model, such as a recurrent neural network (RNN) or long short-term memory (LSTM) model, which has been trained on historical data of user preferences and contextual conditions, may be utilized. The time-series forecasting model may be used to process sequential data (e.g., past behaviors and weather patterns) to predict future preferences. For example, based on past behavior and current weather conditions (like a cold, rainy day), the prediction may be “user prefers a hot coffee with a breakfast sandwich”. The recommendation module 220 may predict the recommendations for the user based on the predicted future user preferences. To enhance relevance of the recommendations, the rank generation module 222 may rank the predicted recommendations based on a probability of acceptance of the recommendation. The recommendations may be ranked from the most to the least probable to be accepted. For example, if historical data shows the user prefers beverages over snacks, a coffee discount may be ranked higher than a snack offer. Further, the recommendation module 220 may generate an appropriate recommendation for the user from among the recommendations based on the ranking.

The UI/UX module 118 may output the generated recommendations for the user on a user interface of the user device 106. The generated recommendations may be displayed on the user interface of the user device 106 in a form of images, animations, interactive notifications/icons, and/or the like. In some examples, the UI/UX module 118 may generate an image for the appropriate recommendation (e.g., the recommendation with the highest ranking among the other recommendations) and display the image of the appropriate recommendation on the user interface of the user device 106. By way of non-limiting example, if the user is in a fueling station, the UI/UX module 118 may generate the image for the appropriate recommendation like a discount on fuel and display the image indicating the discount on the fuel on a digital screen (e.g., the user device 106) employed adjacent to a fuel pump where a car (e.g., the object) associated with the user is present.

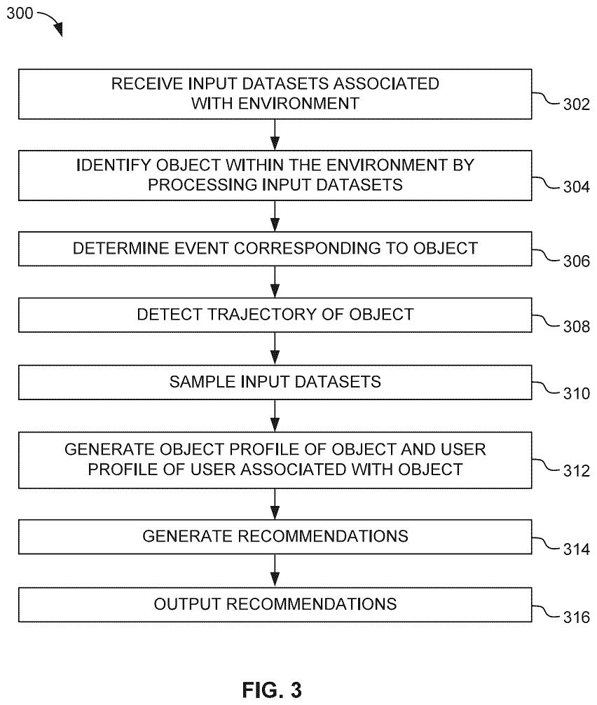

FIG. 3 is a flow diagram that presents an example computer implemented method 300 for generating user and object profiles using Gen-AI models, in accordance with implementations of the present disclosure. In some implementations, the computer implemented method 300 may be executed by the processor 114 of the media processing system 102, as described in relation to FIGS. 1-2. FIG. 3 is explained in conjunction with FIGS. 1-2.

At step 302, the computer implemented method 300 may include receiving, by the processor 114, input datasets associated with an environment from various data sources 112. The input datasets include input media of the environment 110 captured from media capturing systems 104. As will be appreciated for a person skilled in art, the input media may refer to raw data captured from the environment using the media capturing systems 104 (e.g., an image capturing system), which is then processed further for object detection, tracking, event identification, and profile generation. The input media provides visual, audio, spatial, temporal, and/or similar information about objects, people, and activities within the environment (e.g., a gas station or a retail store). Non-limiting examples of the input media include input images, input videos, depth data, thermal images, audio, metadata, image sequences, and/or the like.

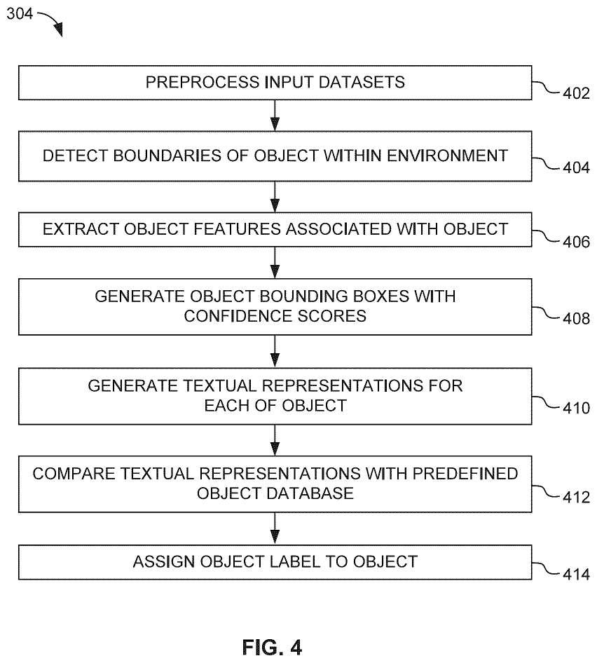

At step 304, the computer implemented method 300 may include identifying, by the processor 114, an object within the environment by processing the input datasets using the vision language model 240 and the computer vision model 242. Identifying the object within the environment is described along with the object identification and tracking module 202 in FIG. 2 and in FIG. 4.

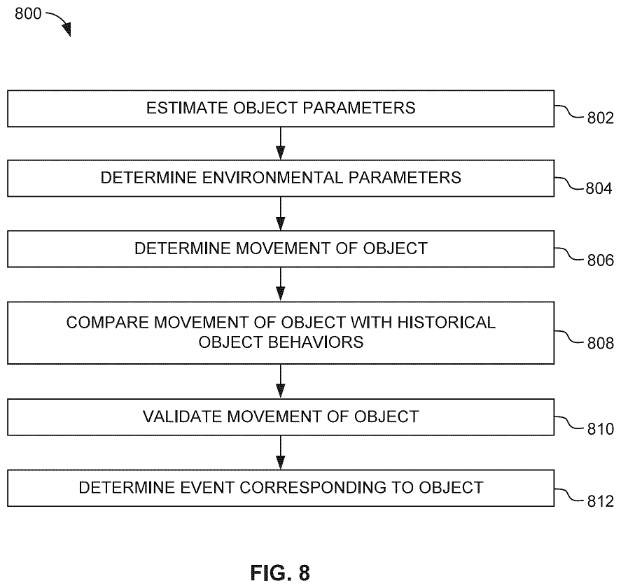

At step 306, the computer implemented method 300 may include determining, by the processor 114, an event corresponding to the object based on a set of object parameters. The event may include an action performed by the object within the environment. Determining the event corresponding to the object is described along with the event determination module 204 in FIG. 2 and in FIG. 8.

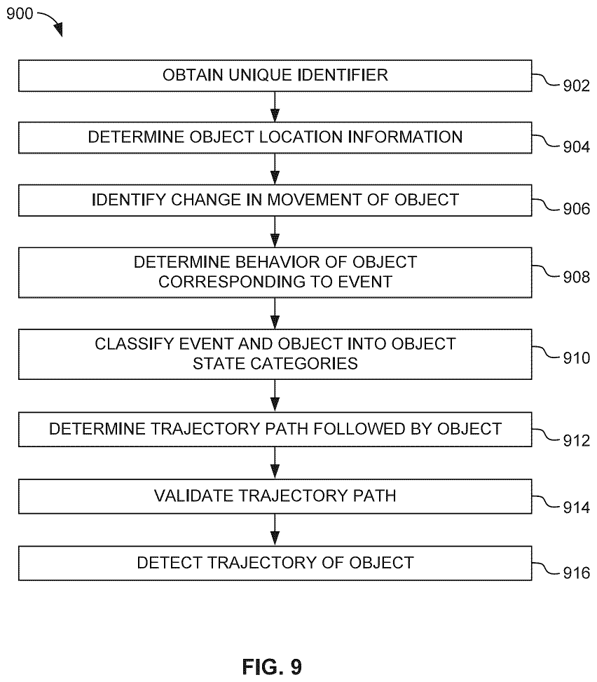

At step 308, the computer implemented method 300 may include detecting, by the processor 114, a trajectory of the object based on the event using the spatial trajectory model 238. Detecting the trajectory of the object is described along with the trajectory detection module 206 in FIG. 2 and in FIG. 9.

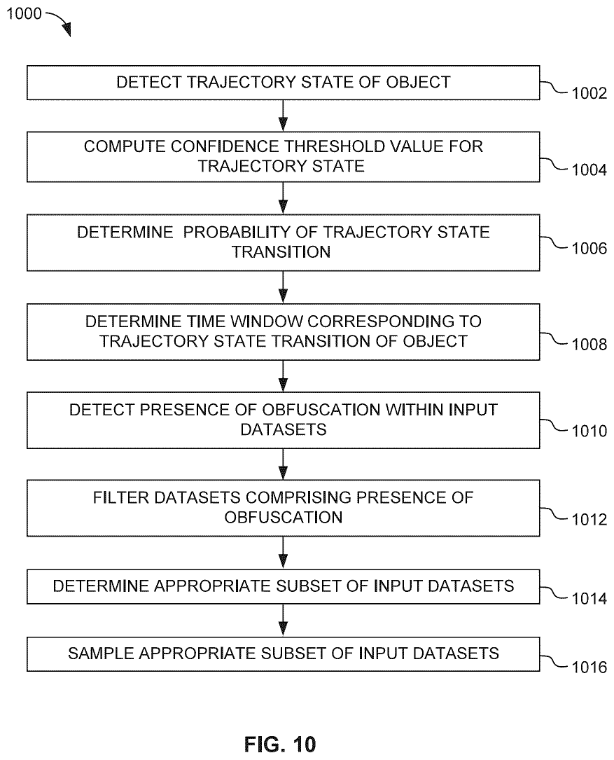

At step 310, the computer implemented method 300 may include sampling, by the processor 114, the input datasets based on the trajectory using a set of sampling parameters. Sampling the input datasets is described along with the sampling module 208 in FIG. 2 and in FIG. 10.

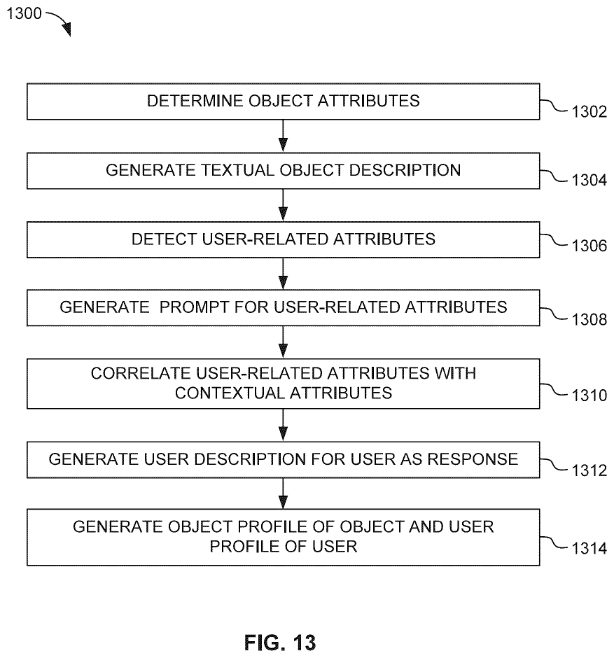

At step 312, the computer implemented method 300 may include generating, by the processor 114, an object profile of the object and a user profile of a user associated with the object based on the sampled datasets. Generating the object profile and the user profile is described along with the profile generation module 210 in FIG. 2 and in FIG. 13.

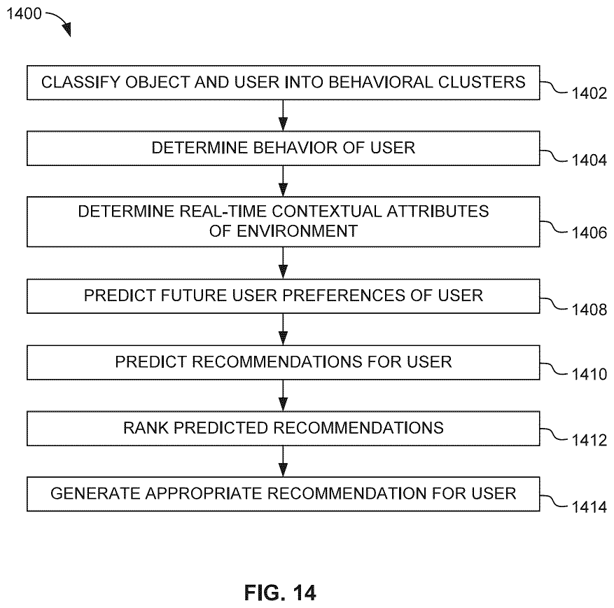

At step 314, the computer implemented method 300 may include generating, by the processor 114, recommendations for the user based on the object profile and the user profile using the Gen-AI model (e.g., one of the Gen-AI models 236). Generating the recommendation is described along with the recommendation generation engine 122 in FIG. 2 and in FIG. 14.

At step 316, the computer implemented method 300 may include outputting, by the processor 114, the recommendations for the user on a user interface of the user device 106.

FIG. 4 is a flow diagram that presents an example computer implemented method 400 for identifying the object within the environment, in accordance with implementations of the present disclosure. In some implementations, the computer implemented method 400 may be executed by the processor 114 using the object identification and tracking module 202. FIG. 4 is explained in conjunction with FIGS. 1-3.

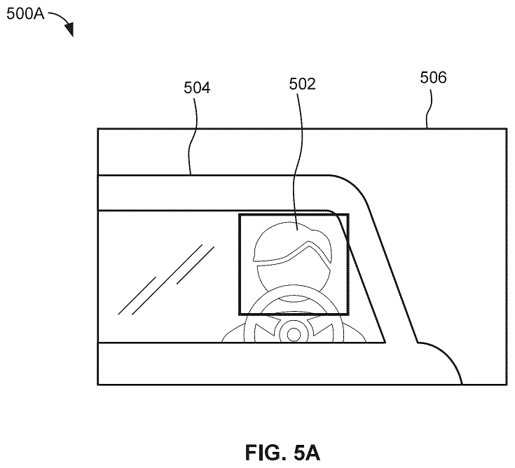

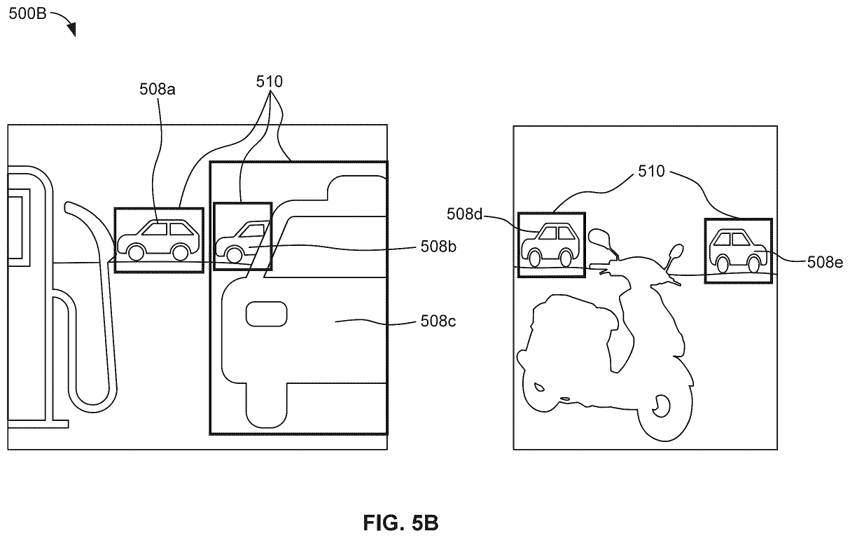

At step 402, the computer implemented method 400 may include preprocessing, by the processor 114, the input datasets by performing a noise reduction, a resolution enhancement, and a format normalization of the input datasets. At step 404, the computer implemented method 400 may include detecting, by the processor 114, boundaries of the object within the environment using the edge-detection model 244. At step 406, the computer implemented method 400 may include extracting, by the processor 114, object features associated with the object using the CNNs 246. The object features include a shape, a color, and a texture of the object. At step 408, the computer implemented method 400 may include generating, by the processor 114, object bounding boxes with confidence scores based on the object features. At step 410, the computer implemented method 400 may include generating, by the processor 114, textual representations for each of the object based on visual embeddings and the object bounding boxes. At step 412, the computer implemented method 400 may include comparing, by the processor 114, the textual representations with the predefined object database 248. At step 414, the computer implemented method 400 may include assigning, by the processor 114, an object label to the object based on a semantic similarity between the textual representations and the predefined object database 248. Exemplary illustrations of the object identification are depicted in FIGS. 5A and 5B.

As depicted in FIG. 5A, a driver 502 of a vehicle 504 may be identified as an object and the bounding boxes 506 are created around the driver 502. In FIG. 5B, vehicles 508a, 508b, 508c, 508d, and 508e are identified as the objects and therefore bounding boxes 510 are created around the vehicles 508a-508d.

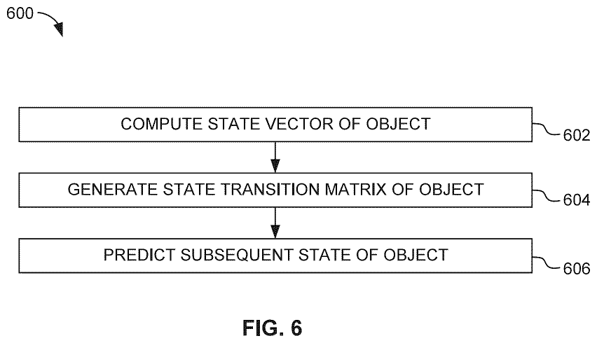

FIG. 6 depicts a flow diagram that presents an example computer implemented method 600 for predicting a subsequent state of the object, in accordance with implementations of the present disclosure. In some implementations, the computer implemented method 600 may be executed by the processor 114 using the object identification and tracking module 202. FIG. 5 is explained in conjunction with FIGS. 1-4.

At step 602, the computer implemented method 600 may include computing, by the processor 114, a state vector of the object based on the set of object parameters. The set of object parameters include a position value and a velocity value of the object. At step 604, the computer implemented method 600 may include generating, by the processor 114, a state transition matrix of the object based on the state vector using the AI model (one of the AI models 232). At step 606, the computer implemented method 600 may include predicting, by the processor 114, the subsequent state of the object based on the state transition matrix.

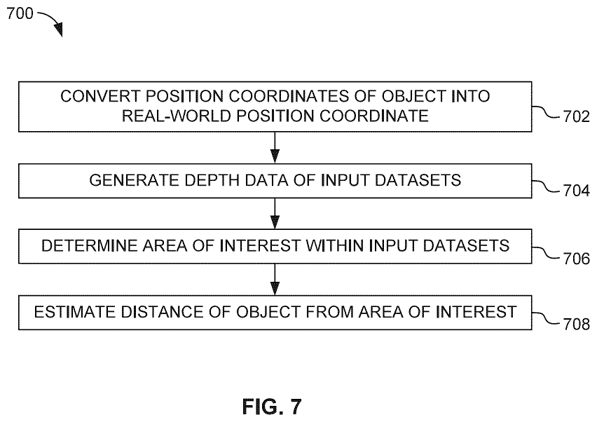

FIG. 7 is a flow diagram that presents an example computer implemented method 700 for estimating distance of the object from an Area of Interest (AOI), in accordance with implementations of the present disclosure. In some implementations, the computer implemented method 700 may be executed by the processor 114 using the object identification and tracking module 202. FIG. 6 is explained in conjunction with FIGS. 1-6.

At step 702, the computer implemented method 700 may include converting, by the processor 114, position coordinates of the identified object into a real-world position coordinate using an estimated homograph matrix. At step 704, the computer implemented method 700 may include generating, by the processor 114, depth data of the received input datasets using the monocular depth estimation model 230. At step 706, the computer implemented method 700 may include determining, by the processor 114, the AOI within the received input datasets based on the generated depth data and the real-world position coordinates of the object. At step 708, the computer implemented method 600 may include estimating the distance of the object from the determined AOI using the AI model (e.g., one of the AI models 232).

FIG. 8 is a flow diagram that presents an example computer implemented method 800 for determining the event corresponding to the object, in accordance with implementations of the present disclosure. In some implementations, the computer implemented method 800 may be executed by the processor 114 using the event determination module 204. FIG. 8 is explained in conjunction with FIGS. 1-7.

At step 802, the computer implemented method 800 may include estimating, by the processor 114, the set of object parameters associated with the object by processing the real-world position coordinates using the Kalman filter-based object tracking model 234. At step 804, the computer implemented method 800 may include determining, by the processor 114, environmental parameters of the environment based on sensor data and multi-media data captured from the media capturing systems 104. The environmental parameters include a time of a day, weather conditions, and a congestion level. At step 806, the computer implemented method 800 may include determining, by the processor 114, a movement of the object based on the estimated set of object parameters, the determined environmental parameters, the subsequent state predicted based on the state transition matrix. At step 808, the computer implemented method 800 may include comparing, by the processor 114, the determined movement of the object with historical object behaviors. At step 810, the computer implemented method 800 validating, by the processor 114, the determined movement of the object using one of the Gen-AI models 236 based on results of comparison. At step 812, the computer implemented method 800 may include determining, by the processor 114, the event corresponding to the object based on results of validation.

FIG. 9 is a flow diagram that presents an example computer implemented method 900 for detecting the trajectory of the object, in accordance with implementations of the present disclosure. In some implementations, the computer implemented method 800 may be executed by the processor 114 using the trajectory detection module 206. FIG. 9 is explained in conjunction with FIGS. 1-8.

At step 902, the computer implemented method 900 may include obtaining, by the processor 114, a unique identifier associated with the object. At step 904, the computer implemented method 900 may include determining, by the processor 114, object location information associated with the object using the spatial trajectory model 238. The object location information may be determined by processing the predicted subsequent state, and a change in a distance of the object using the spatial trajectory model 238. At step 906, the computer implemented method 900 may include identifying, by the processor 114, a change in the movement of the object within the environment based on the unique identifier, and the object location information. At step 908, the computer implemented method 900 may include determining, by the processor 114, a behavior of the object corresponding to the event based on the change. At step 910, the computer implemented method 900 may include classifying, by the processor, the event and the object into object state categories based on the behavior of the object. At step 912, the computer implemented method 900 may include determining, by the processor 114, a trajectory path followed by the object based on the classification. At step 914, the computer implemented method 900 may include validating, by the processor, the trajectory path followed by the object using the Gen-AI model (e.g., one of the Gen-AI models 236). At step 1016, the computer implemented method 900 may include detecting, by the processor 114, the trajectory of the object based on results of validation.

FIG. 10 depicts a flow diagram that presents an example computer implemented method 1000 for sampling the input datasets, in accordance with implementations of the present disclosure. In some implementations, the computer implemented method 1000 may be executed by the processor 114 using the sampling module 208. FIG. 10 is explained in conjunction with FIGS. 1-9.

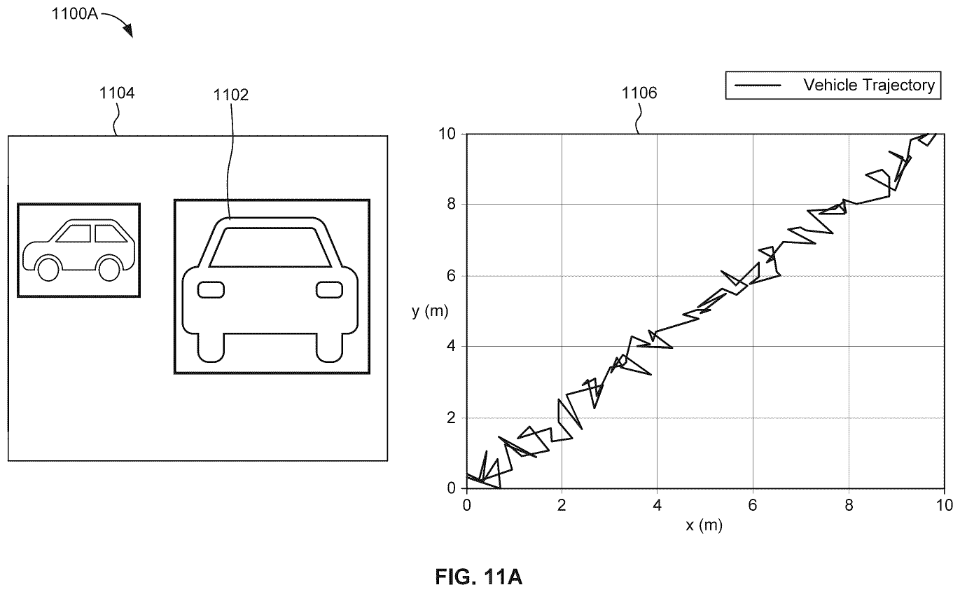

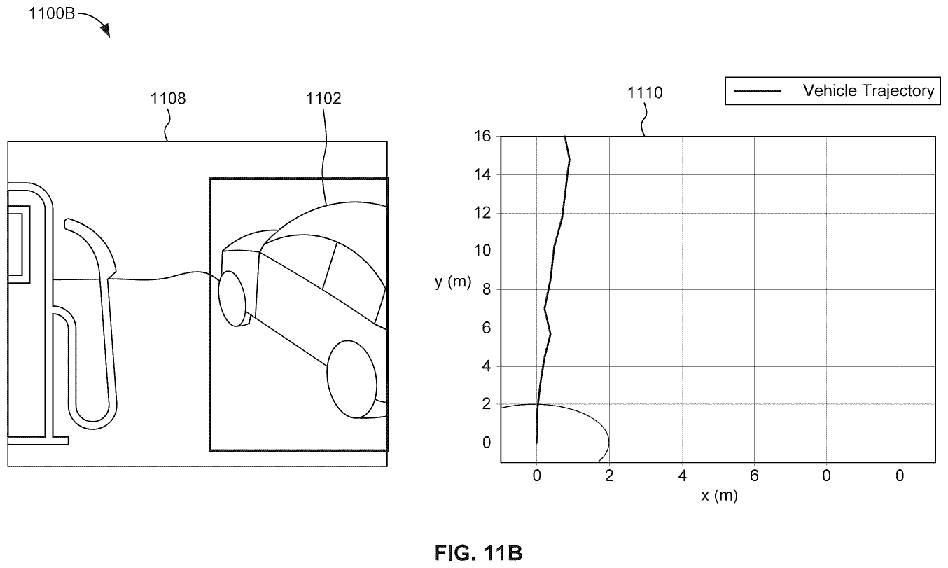

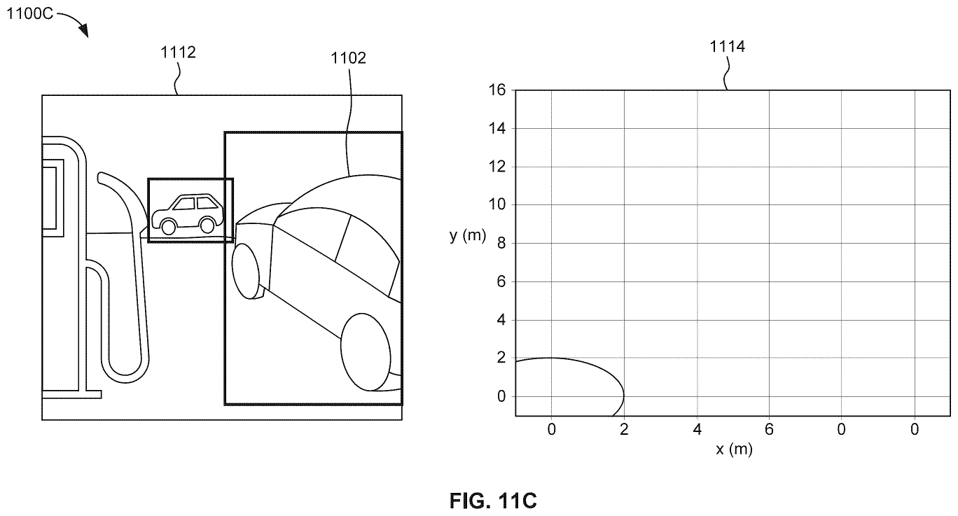

At step 1002, the computer implemented method 1000 may include detecting, by the processor 114, a trajectory state of the object based on the trajectory using the spatial trajectory model 238. For example, in the fueling station environment, the trajectory state may include, but is not limited to, movement towards gas station, transition to gas pump, stationary at gas pump, and/or the like, which are illustrated further in FIGS. 11A-11C, respectively.

As depicted in FIG. 11A, a trajectory state of a vehicle 1102 is depicted as “movement towards gas station”, shown in an input image 1104 where the vehicle 1102 approaches a gas station. A trajectory graph 1106 corresponding to the “movement towards gas station” plots path of the vehicle 1102 with respect to x and y coordinates, illustrating a movement direction of the vehicle 1102. The trajectory graph 1106 shows a steep slope, indicating high velocity, with frequent data points due to a high sampling rate. Further, in FIG. 11B, a trajectory state of the vehicle 1102 is depicted as “transition to gas pump”, shown in an input image 1108 where the vehicle 1102 is at the gas station and velocity of the vehicle 1102 decreases while approaching the gas pump. The decrease in the velocity reflects a shift from rapid to gradual movement of the vehicle 1102. A trajectory graph 1110 corresponding to the “transition to gas pump” plots a path of the vehicle 1102 with respect to x and y coordinates, showing a clear change in movement direction as the vehicle 1102 navigates towards the gas pump. The transition may be marked by a shift from a high to a low sampling rate, corresponding to reduced velocity of the vehicle 1102. The trajectory state “transition to gas pump” indicates that the vehicle 1102 is positioned at the gas pump but has not yet come to a complete stop. In FIG. 11C, a trajectory state of the vehicle 1102 is depicted as “stationary at gas pump”, shown in an input image 1112 where the vehicle 1102 has come to the complete stop at the gas pump. A trajectory graph 1114 corresponding to the “stationary at gas pump” plots a trajectory path of the vehicle 1102 with respect to the x and y coordinates, indicating no significant movement, which is characteristic of a stationary state. The trajectory state “stationary at gas pump” signifies that the vehicle 1102 is at a fixed position. In such cases, a single image is selected and passed to the vision language model 240 since the vehicle 1102 is no longer in motion.

Referring back to FIG. 10, at step 1004, the computer implemented method 1000 may include computing, by the processor 114, a confidence threshold value for the trajectory state based on the set of object parameters. The confidence threshold value indicates a likelihood of a relevant state change. At step 1006, the computer implemented method 1000 may include determining, by the processor 114, a probability of trajectory state transition from a current trajectory state to a subsequent trajectory state based on the confidence threshold value.

At step 1008, the computer implemented method 1000 may include determining, by the processor 114, a time window corresponding to the trajectory state transition of the object based on the probability. At step 1010, the computer implemented method 1000 may include detecting, by the processor 114, a presence of an obfuscation within the input datasets using the vision language model 240. Obfuscation detection is further illustrated for various scenarios in FIGS. 12A-12C.

As depicted in FIGS. 12A-12C, a trajectory state of a vehicle 1202 is depicted as “movement towards gas pump”, in input images 1204, 1206, and 1208. The input images 1204, 1206, and 1208 capture the vehicle 1202 approaching the gas pump, with a trajectory of the vehicle 1202 indicating a clear direction of motion. In FIG. 12A, the input image 1204 shows a vehicle 1202 making a turn to align its path towards the gas pump with minimal obfuscation, as a person 1210 is fueling another vehicle 1212, partially overlaps the vehicle 1202 but covering only a minimal area. The low obfuscation enables accurate detection and tracking of vehicle 1202. Given the clear visibility and low obfuscation, the input image 1204 may be selected for processing by the vision language model 240.

As depicted in FIG. 12B, the input image 1206 shows that the vehicle 1202 has completed the turn and is now directly moving towards the gas pump. The fueling for vehicle 1212 is completed, and a driver 1214 of the vehicle 1212 has seated on the vehicle 1212, which remains stationary with a side stand engaged. The input image 1206 still shows minimal obfuscation, with only slight partial overlap of the vehicle 1212 affecting the visibility of vehicle 1202. The presence of the side stand causes the vehicle 1212 to appear slightly inclined but does not significantly obstruct a view of the vehicle 1202. As the obstruction is minimal, input image 1206 is selected for processing by vision language model 240.

As depicted in FIG. 12C, the input image 1208 shows that the driver 1214 of the vehicle 1212 has released the side stand, causing the vehicle 1212 to adjust to become upright and straight and an entry of another vehicle 1216. The adjustment results in a more pronounced overlap with the vehicle 1202, leading to medium-level obfuscation. The increase in obstruction affects the accuracy of detection and tracking of the vehicle 1202. Consequently, the input image 1208 may be restricted from processing by vision language model 240.

Referring back to FIG. 10, at step 1012, the computer implemented method 1000 may include filtering, by the processor 114, datasets including the presence of the obfuscation from the input datasets. At step 1014, the computer implemented method 1000 may include determining, by the processor 114, an appropriate subset of the input datasets based on the filtered datasets and the determined probability using the Gen-AI model (e.g., one of the Gen-AI models 236). The appropriate subset includes image frames of the object selected based on the set of object parameters and the trajectory state transition. At step 1016, the computer implemented method 1000 may include sampling, by the processor 114, the appropriate subset of the input datasets based on a sampling rate, the probability, and the time window. The sampling rate includes a frame rate, an object occlusion status, and confidence threshold value. In some implementations, the sampling rate may be adjusted dynamically based on one of a velocity of the object, and the object from the AOI. Further, the Gen-AI model (e.g., one of the Gen-AI models 236) may be fine-tuned based on the dynamically adjusted sampling rate. Steps 1002-1016 are explained in detail in conjunction with the sampling module 208 in FIG. 2, therefore repeated description is omitted for sake of brevity.

FIG. 13 is a flow diagram that presents an example computer implemented method 1300 for generating the object profile of the object and the user profile of the user associated with an object, in accordance with implementations of the present disclosure. In some implementations, the computer implemented method 1000 may be executed by the profile generation module 210. FIG. 13 is explained in conjunction with FIGS. 1-12.

At step 1302, the computer implemented method 1300 may include determining, by the processor 114, object attributes corresponding to the object by analyzing the sampled datasets. The object attributes include one of a make and a model of the object, a physical condition of the object, and a license plate. At step 1304, the computer implemented method 1300 may include generating, by the processor 114, a textual object description of the object by applying the object attributes to the vision language model 240. At step 1306, the computer implemented method 1300 may include detecting, by the processor 114, user-related attributes corresponding to the user from the sampled datasets. The user-related attributes include a number of occupants visible around the object, an age group of the user, a browsing behavior, a user behavior, a user purchase history, a user lifestyle history, and a user visit frequency.

At step 1308, the computer implemented method 1300 may include generating, by the processor 114, a prompt for the user-related attributes corresponding to the user. At step 1310, the computer implemented method 1300 may include correlating, by the processor 114, the user-related attributes with contextual attributes using the Gen-AI model (e.g., one of the Gen-AI models 236) in response to the prompt. The contextual attributes include a time of day and weather conditions, and historical transaction data of similar users. At step 1312, the computer implemented method 1300 may include generating, by the processor 114, a user description for the user as a response based on the correlation. At step 1314, the computer implemented method 1300 may include generating, by the processor 114, the object profile of the object and the user profile of the user based on the user description and the textual object description. Steps 1302-1314 are explained in detail in conjunction with the profile generation module 210 in FIG. 2, therefore repeated description is omitted for sake of brevity.

FIG. 14 is a flow diagram that presents an example computer implemented method 1400 for generating the recommendations for the user, in accordance with implementations of the present disclosure. The computer implemented method 1400 may be executed by the processor 114 using the various module 212-222 of the recommendation generation engine 122. FIG. 14 is explained in conjunction with FIGS. 1-13.

At step 1402, the computer implemented method 1400 may include classifying, by the processor 114, the object and the user into behavioral clusters based on the textual object description and the user description, using the classification module 212. At step 1404, the computer implemented method 1400 may include determining, by the processor 114, a behavior of the user based on the behavioral clusters and a similar user behavior prestored in the database 224, using the behavior determination module 214. At step 1406, the computer implemented method 1400 may include determining, by the processor 114, real-time contextual attributes of the environment from the data sources 112, using the attribute determination module 216. At step 1408, the computer implemented method 1400 may include predicting, by the processor 114, future user preferences of the user by correlating the determined behavior with the determined real-time contextual attributes, using the preference prediction module 218.

At step 1410, the computer implemented method 1400 may include predicting, by the processor 114, recommendations for the user based on the predicted future user preferences, using the recommendation module 220. At step 1412, the computer implemented method 1400 may include ranking, by the processor 114, the predicted recommendations based on a probability of acceptance of the recommendations, using the rank generation module 222. At step 1414, the computer implemented method 1400 may include generating, by the processor 114, an appropriate recommendation for the user from among the recommendations based on the ranking, using the recommendation module 220.

Implementations of the present disclosure provides a comprehensive, real-time, and highly personalized experience framework for object identification and tracking across various sectors/fields such as gas stations, convenience stores, retail outlets, and/or the like. With the proposed framework, objects and/or users associated with the objects in an environment may be identified and tracked by integrating and analyzing a movement of each of the objects/a behavior of each of the users with real-time context attributes associated with an environment using a combination of Gen AI-models and efficient data processing techniques. Therefore, the objects and/or the associated users may be accurately identified and efficiently tracked with reduced time and utilization of computing resources. Further, the objects and/or users associated with the objects in the environment may be accurately identified and tracked even in presence of multiple other objects in the environment and even if the input datasets associated with the environment include complex multimodal datasets.

Accurate identification and tracking of the objects and/or the users may further aid in creating user profiles and object profiles efficiently. The user profiles and object profiles may be used to generate recommendations. Therefore, implementations of the present disclosure deliver a dynamic and responsive user (e.g., customer) engagement framework that significantly enhances both user (e.g., customer) satisfaction and revenue generation. Implementations of the present disclosure further enable transforming of raw video footage from surveillance cameras into actionable insights, enabling personalized offers, service interventions, and optimized enterprise operations in real-time.

Implementations provide granular user and object profiling personalization. The media processing system analyzes multi-camera feeds, identifies objects entering premises, tracks interactions of the objects with other objects, and generates detailed profiles of the user and the object based on object attributes such as make, model, modifications, condition, and/or presence of specific features (e.g., roof racks, all-weather tires, and/or the like). The generation of user and object profiles is enhanced by integrating historical transaction data through unique identifiers, allowing for seamless identification and tracking of repeat objects. The media processing system facilitates hyper-personalized offer generation, tailored to individual preferences, lifestyle, and immediate needs, thereby increasing the likelihood of conversion and user (e.g., customer) retention.

Implementations enable real-time object interaction tracking. The media processing system employs object detection and trajectory processing methods to accurately identify and track objects as the objects approach, interact with, and depart from premises. The real-time tracking enables the media processing to detect key service moments, such as fueling initiation, auto shutoff, and payment completion. By monitoring the interactions, the media processing system triggers timely interventions, such as alerting staff to provide assistance or recommending additional services based on the behavior and profile of the users (e.g., customers). The media processing system has an ability to differentiate between different objects (e.g., vehicles, motorcycles, and other types of transportation) which enhances precision of service delivery and operational efficiency.

Implementations provide dynamic offer generation capability. The media processing system integrates multiple data sources including object and user profiles, real-time weather conditions, time of day, and current promotional activities, to identify the most relevant offers for each user (e.g., customer). The media processing system utilizes Gen-AI models to create engaging offer content, which is then displayed on digital screens (e.g., on screens at a pump or within a store). The engaging offer content is dynamically customized based on the individual's inferred preferences, layout of the premises, and localized marketing strategies. Moreover, the media processing system generates visually appealing marketing images tailored to specific offers, enhancing the effectiveness of promotional campaigns and driving higher sales conversion rates.

The implementations provide privacy and data security compliance. In alignment with stringent privacy regulations and user (e.g., customer) data protection standards, the media processing system incorporates robust anonymization protocols at source, which ensures that Personally Identifiable Information (PII), such as license plate numbers and facial recognition data, is anonymized before any processing occurs. The media processing system supports deployment on-premises or within private cloud environments, ensuring that sensitive data does not leave client's infrastructure. Additionally, the media processing system has customizable privacy filters, allowing organizations to adjust a level of anonymization based on specific regulatory and compliance requirements of the organizations.

Implementations provides optimized architecture of the media processing system for scalability and efficiency. Implementations employ a hybrid edge-cloud architecture to balance processing efficiency, cost-effectiveness, and data privacy. Edge servers handle real-time video processing, reducing latency and bandwidth consumption, while cloud-based components manage data analytics, offer generation, and profile enrichment. The optimized architecture ensures high availability and scalability, enabling deployment across multiple locations with minimal infrastructure overhead.

Implementations provide enhanced user (e.g., customer) service and operational insights. Beyond personalized marketing, the media processing system provides actionable insights into user (e.g., customer) service quality and operational performance. By analyzing service events, such as wait times, fueling duration, and user (e.g., customer) interactions, the media processing system enables real-time monitoring of Key Performance Indicators (KPIs). Therefore, the media processing system optimize staff allocation, and improve overall user (e.g., customer) experience. For example, the media processing system trigger alerts for extended wait times, prompting proactive intervention by staff to maintain service excellence.

Implementations provide a capability of delivering personalized offers in the absence of historical transaction data, addressing a challenge of cold-start scenarios, which is achieved through advanced few-shot learning techniques and collaborative filtering models that leverage user (e.g., customer) descriptions inferred from visual data and behavior patterns. By comparing new users (e.g., customers) with similar profiles from the recent past, the media processing system recommends relevant offers with high confidence, ensuring that every user (e.g., customer) receives a personalized experience regardless of loyalty status of the user (e.g., customer).

Implementations incorporate feedback that monitors performance of offers and service interventions over time. The feedback is used to continuously refine the profiles of the user and the objects, improving offer propensity, and optimize marketing strategies. The adaptive learning capability ensures that the media processing system evolves with changing behaviors of the users (e.g., customers), seasonal trends, and market dynamics, thereby maintaining high levels of personalization and relevance.

In some environments, for example, retail stores, the spatial trajectory model may be used to optimize real-time processing by tracking object specific action occurring, such as browsing or preparing for checkout. Instead of calling the Gen-AI model for every minor movement, the media processing system analyzes various attributes such as changes in speed, direction, and behavior patterns to identify significant events. As a result, unnecessary computational load is reduced, and speeds of decision-making is boosted, ensuring efficient resource usage, enabling quick, accurate responses that enhance user (e.g., customer) experience and streamline operations.

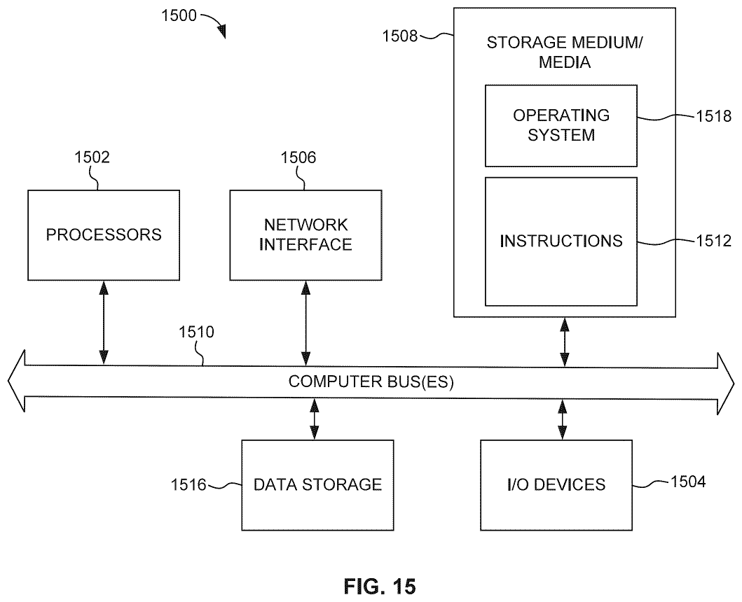

FIG. 15 depicts a computer system 1500 that may be used to implement the media processing system 102. More particularly, computing machines such as desktops, laptops, smartphones, tablets, and wearables which may be used for generating object and user profiles using Gen-AI models. The computer system 1500 may include additional components not shown and that some of the process components described may be removed and/or modified. In another example, the computer system 1500 may be deployed on external-cloud platforms such as cloud, internal corporate cloud computing clusters, organizational computing resources, and/or the like.

The computer system 1500 includes processor(s) 1502, such as a central processing unit, an application specific integrated circuit (ASIC) or another type of processing circuit, input/output devices 1504, such as a display, mouse keyboard, etc., a network interface 1506, such as a Local Area Network (LAN), a wireless 802.11x LAN, a 3G or 4G or 5G mobile WAN or a WiMax WAN, and a storage medium/media 1508. Each of these components may be operatively coupled to a computer bus 1510. The storage medium/media 1508 may be any suitable medium that participates in providing instructions to the processor(s) 1502 for execution. For example, the storage medium/media 1508 may be non-transitory or non-volatile medium, such as a magnetic disk or solid-state non-volatile memory or volatile medium such as RAM. The instructions or modules stored on the storage medium/media 1508 may include machine-readable instructions 1512 executed by the processor(s) 1502 that cause the processor(s) 1502 to perform the methods and functions of the media processing system 102.

The media processing system 102 may be implemented as software stored on a non-transitory processor-readable medium and executed by the processor(s) 1502. For example, the storage medium/media 1508 may store an operating system 1514, such as MAC OS, MS WINDOWS, UNIX, or LINUX, and code, for the media processing system 102. The operating system 1514 may be multi-user, multiprocessing, multitasking, multithreading, real-time, and the like. For example, during runtime, the operating system 1514 is running and the code for the media processing system 102 is executed by the processor(s) 1502.

The computer system 1500 may include a data storage 1516, which may include non-volatile data storage. The data storage 1516 stores any data used or generated by the media processing system 102.

The network interface 1506 connects the computer system 1500 to internal systems for example, via a LAN. Also, the network interface 1506 may connect the computer system 1500 to the Internet. For example, the computer system 1500 may connect to web browsers and other external applications and systems via the network interface 1506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 1502 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive input datasets associated with an environment from a plurality of data sources, wherein the input datasets comprise input media of the environment captured from a plurality of media capturing systems;
identify at least one object within the environment by processing the received input datasets using a vision language model and a computer vision model;
determine at least one event corresponding to the identified at least one object based on a set of object parameters, wherein the at least one event comprises at least one action performed by the at least one object within the environment;
detect at least one trajectory of the at least one object based on the determined at least one event using a spatial trajectory model;
sample the received input datasets based on the detected at least one trajectory using a set of sampling parameters;
generate an object profile of the at least one object and a user profile of a user associated with the at least one object based on the sampled datasets;
generate a plurality of recommendations for the user based on the generated object profile and the user profile using a Generative Artificial-Intelligence (Gen-AI) model; and
output the generated plurality of recommendations for the user on a user interface of a user device.

2. The system of claim 1, wherein to identify the at least one object within the environment by processing the received input datasets using the vision language model and the computer vision model, the processor is configured to:
preprocess the received input datasets by performing a noise reduction, a resolution enhancement, and a format normalization of the received input datasets;
detect boundaries of the at least one object within the environment using an edge-detection model;
extract a plurality of object features associated with the at least one object using Convolutional Neural Networks (CNNs), wherein the plurality of object features comprise a shape, a color, and a texture of the at least one object;
generate object bounding boxes with a plurality of confidence scores based on the extracted plurality of object features;
generate a plurality of textual representations for each of the at least one object based on visual embeddings and the generated object bounding boxes;
compare the generated plurality of textual representations with a predefined object database; and
assign at least one object label to the at least one object based on a semantic similarity between the generated plurality of textual representations and the predefined object database.

3. The system of claim 1, wherein the processor is configured to:
compute a state vector of the at least one object based on the set of object parameters, wherein the set of object parameters comprise a position value and a velocity value of the at least one object;
generate a state transition matrix of the at least one object based on the computed state vector using an Artificial-Intelligence model; and
predict a subsequent state of the at least one object based on the generated state transition matrix.

4. The system of claim 1, wherein the processor is configured to:
convert position coordinates of the identified at least one object into a real-world position coordinate using an estimated homograph matrix;
generate depth data of the received input datasets using a monocular depth estimation model;
determine an area of interest within the received input datasets based on the generated depth data and the real-world position coordinates of the at least one object; and
estimate a distance of the at least one object from the determined area of interest using an Artificial-Intelligence model.

5. The system of claim 1, wherein to determine the at least one event corresponding to the identified at least one object based on the set of object parameters, the processor is configured to:
estimate the set of object parameters associated with the at least one object by processing the real-world position coordinates using a Kalman filter-based object tracking model;
determine a plurality of environmental parameters of the environment based on sensor data and multi-media data captured from the plurality of media capturing systems, wherein the plurality of environmental parameters comprise a time of a day, weather conditions, and a congestion level;
determine a movement of the at least one object based on the estimated set of object parameters and the determined plurality of environmental parameters;
compare the determined movement of the at least one object with historical object behaviors;
validate the determined movement of the at least one object using a Generative Artificial-Intelligence (Gen-AI) model based on results of comparison; and
determine the at least one event corresponding to the identified at least one object based on results of validation.

6. The system of claim 1, wherein to detect the at least one trajectory of the at least one object based on the determined at least one event using the spatial trajectory model, the processor is configured to:
obtain a unique identifier;
determine object location information associated with the at least one object using the spatial trajectory model, wherein the object location information is determined by processing a predicted subsequent state, and a change in a distance of the at least one object using the spatial trajectory model;
identify at least one change in a movement of the at least one object within the environment based on the determined unique identifier, and the object location information;
determine a behavior of the at least one object corresponding to the determined at least one event based on the identified at least one change;
classify the at least one event and the at least one object into a plurality of object state categories based on the determined behavior of the at least one object;
determine a trajectory path followed by the at least one object based on the classification;
validate the determined trajectory path followed by the at least one object using a Generative Artificial-Intelligence (Gen-AI) model; and
detect the at least one trajectory of the at least one object based on results of validation.

7. The system of claim 1, wherein to sample the received input datasets based on the detected at least one trajectory using a set of sampling parameters, the processor is configured to:
detect a trajectory state of the at least one object based on the detected at least one trajectory using the spatial trajectory model;
compute a confidence threshold value for the detected trajectory state based on the set of object parameters, wherein the confidence threshold value indicates a likelihood of a relevant state change;
determine a probability of trajectory state transition from a current trajectory state to a subsequent trajectory state based on the computed confidence threshold value;
determine a time window corresponding to the trajectory state transition of the at least one object based on the determined probability;
detect a presence of an obfuscation within the received input datasets using the vision language model;
filter a plurality of datasets comprising the presence of the obfuscation from the received input datasets;
determine an appropriate subset of the received input datasets based on the filtered datasets and the determined probability using a Gen-AI model, wherein the appropriate subset comprises a plurality of image frames of the at least one object selected based on the set of object parameters and the trajectory state transition; and
sample the determined appropriate subset of the received input datasets based on a sampling rate, the determined probability, and the determined time window, wherein the sampling rate comprises a frame rate, an object occlusion status, and confidence threshold value.

8. The system of claim 7, wherein the processor is configured to:
dynamically adjust the sampling rate based on at least one of a velocity of the at least one object, and the at least one object from an area of interest (AOI); and
fine-tune the Gen-AI model based on the dynamically adjusted sampling rate.

9. The system of claim 1, wherein to generate the object profile of the at least one object and the user profile of the user associated with the at least one object based on the sampled datasets, the processor is configured to:
determine object attributes corresponding to the at least one object by analyzing the sampled datasets, wherein the object attributes comprise at least one of a make and a model of the object, a physical condition of the object, and a license plate;
generate a textual object description of the at least one object by applying the determined object attributes to the vision language model;
detect user-related attributes corresponding to the user from the sampled datasets, wherein the user-related attributes comprise a number of occupants visible around the object, an age group of the user, a browsing behavior, a user behavior, a user purchase history, a user lifestyle history, and a user visit frequency;
generate at least one prompt for the detected user-related attributes corresponding to the user;
correlate the detected user-related attributes with a plurality of contextual attributes using Generative Artificial Intelligence (Gen-AI) model in response to the at least one generated prompt, wherein the plurality of contextual attributes comprise a time of day and weather conditions, and historical transaction data of similar users;
generate a user description for the user as a response based on the correlation; and
generate the object profile of the at least one object and the user profile of the user based on the generated user description and the textual object description.

10. The system of claim 1, wherein to generate the plurality of recommendations for the user based on the generated object profile and the user profile using the Gen-AI model, the processor is configured to:
classify the at least one object and the user into a plurality of behavioral clusters based on generated textual object description and the user description;
determine a behavior of the user based on the classified behavioral clusters and a similar user behavior prestored in a database;
determine real-time contextual attributes of the environment from the plurality of data sources;
predict future user preferences of the user by correlating the determined behavior with the determined real-time contextual attributes;
predict a plurality of recommendations for the user based on the predicted future user preferences;
rank the predicted plurality of recommendations based on a probability of acceptance of the recommendation; and
generate an appropriate recommendation for the user from among the plurality of recommendations based on the ranking.

11. A method comprising:
receiving, by a processor, input datasets associated with an environment from a plurality of data sources, wherein the input datasets comprise input media of the environment captured from a plurality of media capturing systems;
identifying, by the processor, at least one object within the environment by processing the received input datasets using a vision language model and a computer vision model;
determining, by the processor, at least one event corresponding to the identified at least one object based on a set of object parameters, wherein the at least one event comprises at least one action performed by the at least one object within the environment;
detecting, by the processor, at least one trajectory of the at least one object based on the determined at least one event using a spatial trajectory model;
sampling, by the processor, the received input datasets based on the detected at least one trajectory using a set of sampling parameters;
generating, by the processor, an object profile of the at least one object and a user profile of a user associated with the at least one object based on the sampled datasets;
generating, by the processor, a plurality of recommendations for the user based on the generated object profile and the user profile using a Generative Artificial-Intelligence (Gen-AI) model; and
outputting, by the processor, the generated plurality of recommendations for the user on a user interface of a user device.

12. The method of claim 11, wherein identifying the at least one object within the environment by processing the received input datasets using the vision language model and the computer vision model comprises:
preprocessing, by the processor, the received input datasets by performing a noise reduction, a resolution enhancement, and a format normalization of the received input datasets;
detecting, by the processor, boundaries of the at least one object within the environment using an edge-detection model;
extracting, by the processor, a plurality of object features associated with the at least one object using Convolutional Neural Networks (CNNs), wherein the plurality of object features comprise a shape, a color, and a texture of the at least one object;
generating, by the processor, object bounding boxes with a plurality of confidence scores based on the extracted plurality of object features;
generating, by the processor, a plurality of textual representations for each of the at least one object based on visual embeddings and the generated object bounding boxes;
comparing, by the processor, the generated plurality of textual representations with a predefined object database; and
assigning, by the processor, at least one object label to the at least one object based on a semantic similarity between the generated plurality of textual representations and the predefined object database.

13. The method of claim 11, further comprising:
computing, by the processor, a state vector of the at least one object based on the set of object parameters, wherein the set of object parameters comprise a position value and a velocity value of the at least one object;
generating, by the processor, a state transition matrix of the at least one object based on the computed state vector using an Artificial-Intelligence (AI) model; and
predicting, by the processor, a subsequent state of the at least one object based on the generated state transition matrix.

14. The method of claim 11, wherein determining the at least one event corresponding to the identified at least one object based on the set of object parameters comprises:
estimating, by the processor, the set of object parameters associated with the at least one object by processing the real-world position coordinates using a Kalman filter-based object tracking model;
determining, by the processor, a plurality of environmental parameters of the environment based on sensor data and multi-media data captured from the plurality of media capturing systems, wherein the plurality of environmental parameters comprise a time of a day, weather conditions, and a congestion level;
determining, by the processor, a movement of the at least one object based on the estimated set of object parameters and the determined plurality of environmental parameters;
comparing, by the processor, the determined movement of the at least one object with historical object behaviors;
validating, by the processor, the determined movement of the at least one object using a Generative Artificial-Intelligence (Gen-AI) model based on results of comparison; and
determining, by the processor, the at least one event corresponding to the identified at least one object based on results of validation.

15. The method of claim 11, wherein detecting the at least one trajectory of the at least one object based on the determined at least one event using the spatial trajectory model comprises:
obtaining, by the processor, a unique identifier;
determining, by the processor, object location information associated with the at least one object using the spatial trajectory model, wherein the object location information is determined by processing a predicted subsequent state, and a change in a distance of the at least one object using the spatial trajectory model;
identifying, by the processor, at least one change in a movement of the at least one object within the environment based on the determined unique identifier, and the object location information;
determining, by the processor, a behavior of the at least one object corresponding to the determined at least one event based on the identified at least one change;
classifying, by the processor, the at least one event and the at least one object into a plurality of object state categories based on the determined behavior of the at least one object;
determining, by the processor, a trajectory path followed by the at least one object based on the classification;
validating, by the processor, the determined trajectory path followed by the at least one object using a Generative Artificial-Intelligence (Gen-AI) model; and
detecting, by the processor, the at least one trajectory of the at least one object based on results of validation.

16. The method of claim 11, wherein sampling the received input datasets based on the detected at least one trajectory using a set of sampling parameters comprises:
detecting, by the processor, a trajectory state of the at least one object based on the detected at least one trajectory using the spatial trajectory model;
computing, by the processor, a confidence threshold value for the detected trajectory state based on the set of object parameters, wherein the confidence threshold value indicates a likelihood of a relevant state change;
determining, by the processor, a probability of trajectory state transition from a current trajectory state to a subsequent trajectory state based on the computed confidence threshold value;
determining, by the processor, a time window corresponding to the trajectory state transition of the at least one object based on the determined probability;
detecting, by the processor, a presence of an obfuscation within the received input datasets using the vision language model;
filtering, by the processor, a plurality of datasets comprising the presence of the obfuscation from the received input datasets;
determining, by the processor, an appropriate subset of the received input datasets based on the filtered datasets and the determined probability using a Gen-AI model, wherein the appropriate subset comprises a plurality of image frames of the at least one object selected based on the set of object parameters and the trajectory state transition; and
sampling, by the processor, the determined appropriate subset of the received input datasets based on a sampling rate, the determined probability, and the determined time window, wherein the sampling rate comprises a frame rate, an object occlusion status, and confidence threshold value.

17. The method of claim 16, further comprising:
dynamically adjusting, by the processor, the sampling rate based on at least one of a velocity of the at least one object, and a distance of the at least one object from an area of interest (AOI); and
fine-tuning, by the processor, the Gen-AI model based on the dynamically adjusted sampling rate.

18. The method of claim 11, wherein generating the object profile of the at least one object and the user profile of the user associated with the at least one object based on the sampled datasets comprises:
determining, by the processor, object attributes corresponding to the at least one object by analyzing the sampled datasets, wherein the object attributes comprise at least one of a make and a model of the object, a physical condition of the object, and a license plate;
generating, by the processor, a textual object description of the at least one object by applying the determined object attributes to the vision language model;
detecting, by the processor, user-related attributes corresponding to the user from the sampled datasets, wherein the user-related attributes comprise a number of occupants visible around the object, an age group of the user, a browsing behavior, a user behavior, a user purchase history, a user lifestyle history, and a user visit frequency;
generating, by the processor, at least one prompt for the detected user-related attributes corresponding to the user;
correlating, by the processor, the detected user-related attributes with a plurality of contextual attributes using Generative Artificial Intelligence (Gen-AI) model in response to the at least one generated prompt, wherein the plurality of contextual attributes comprise a time of day and weather conditions, and historical transaction data of similar users;
generating, by the processor, a user description for the user as a response based on the correlation; and
generating, by the processor, the object profile of the at least one object and the user profile of the user based on the generated user description and the textual object description.

19. The method of claim 11, wherein generating the plurality of recommendations for the user based on the generated object profile and the user profile using the Gen-AI model comprises:
classifying, by the processor, the at least one object and the user into a plurality of behavioral clusters based on generated textual object description and the user description;
determining, by the processor, a behavior of the user based on the classified behavioral clusters and a similar user behavior prestored in a database;
determining, by the processor, real-time contextual attributes of the environment from a plurality of data sources;
predicting, by the processor, future user preferences of the user by correlating the determined behavior with the determined real-time contextual attributes;
predicting, by the processor, a plurality of recommendations for the user based on the predicted future user preferences;
ranking, by the processor, the predicted plurality of recommendations based on a probability of acceptance of the recommendations; and
generating, by the processor, an appropriate recommendation for the user from among the plurality of recommendations based on the ranking.

20. A non-transitory computer readable medium comprising a processor-executable instructions that cause a processor to:
receive input datasets associated with an environment from a plurality of data sources, wherein the input datasets comprise input media of the environment captured from a plurality of media capturing systems;
identify at least one object within the environment by processing the received input datasets using a vision language model and a computer vision model;
determine at least one event corresponding to the identified at least one object based on a set of object parameters, wherein the at least one event comprises at least one action performed by the at least one object within the environment;
detect at least one trajectory of the at least one object based on the determined at least one event using a spatial trajectory model;
sample the received input datasets based on the detected at least one trajectory using a set of sampling parameters;
generate an object profile of the at least one object and a user profile of a user associated with the at least one object based on the sampled datasets;
generate a plurality of recommendations for the user based on the generated object profile and the user profile using a Generative Artificial-Intelligence (Gen-AI) model; and
output the generated plurality of recommendations for the user on a user interface of a user device.
